(19) United States
(12) Patent Application Publication
(10) Pub. No.: US 2026/0057215 A1
(43) Pub. Date: Feb. 26, 2026

(54) INFORMATION PROCESSING DEVICE

(71) Applicant: SONY SEMICONDUCTOR SOLUTIONS CORPORATION, KANAGAWA (JP)

(72) Inventors: KOHEI MATSUDA, KANAGAWA (JP); KATSUHIKO HANZAWA, KANAGAWA (JP); MASATO MOTOMURA, KANAGAWA (JP); JAEHOON YU, KANAGAWA (JP)

(21) Appl. No.: 19/104,368

(22) PCT Filed: Jul. 4, 2023
(86) PCT No.: PCT/JP2023/024733

§ 371 Date: Feb. 18, 2025

(30) Foreign Application Priority Data
Aug. 24, 2022 (JP) 2022-132955

(51) Int. Cl. G06N 3/0464

(52) U.S. Cl. CPC G06N 3/0464

(57) ABSTRACT

An information processing device according to an embodiment of the present disclosure includes: a storage section that is configured to store a plurality of pieces of word data each including at least one of a piece of processing target data or a piece of weighting coefficient data, and is configured to be accessed in word data units; a convolution operation section that is configured to perform a convolution operation on the basis of the piece of processing target data and the piece of weighting coefficient data; and a post-processing operation section that is configured to perform a predetermined operation on the basis of an operation result of the convolution operation and store the operation result as the piece of processing target data in the storage section. The piece of weighting coefficient data includes a plurality of pieces of coefficient data each including a plurality of pieces of bit data. The plurality of pieces of word data includes a piece of first word data including two or more pieces of most significant bit data provided side by side, the two or more pieces of most significant bit data being in two or more pieces of coefficient data among the plurality of pieces of coefficient data.

### TECHNICAL FIELD

The present disclosure relates to an information processing device that performs processing using a neural network.

### BACKGROUND ART

In a neural network, a convolution operation is performed. For example, PTL 1 discloses a technique of generating one piece of map data by reordering pieces of data included in a plurality of pieces of map data.

### CITATION LIST

### Patent Literature

PTL 1: Japanese Unexamined Patent Application Publication (Published Japanese Translation of PCT Application) No. JP2019-535079

### SUMMARY OF THE INVENTION

Incidentally, in an information processing device, reduction in power consumption is desired, and it is expected to further reduce power consumption.

It is desirable to provide an information processing device that makes it possible to reduce power consumption.

A first information processing device according to one embodiment of the present disclosure includes a storage section, a convolution operation section, and a post-processing operation section. The storage section is configured to store a plurality of pieces of word data each including at least one of a piece of processing target data or a piece of weighting coefficient data, and is configured to be accessed in word data units. The convolution operation section is configured to perform a convolution operation on the basis of the piece of processing target data and the piece of weighting coefficient data. The post-processing operation section is configured to perform a predetermined operation on the basis of an operation result of the convolution operation and store the operation result as the piece of processing target data in the storage section. The piece of weighting coefficient data includes a plurality of pieces of coefficient data each including a plurality of pieces of bit data. The plurality of pieces of word data includes a piece of first word data including two or more pieces of most significant bit data provided side by side, the two or more pieces of most significant bit data being in two or more pieces of coefficient data among the plurality of pieces of coefficient data.

A second information processing device according to one embodiment of the second embodiment includes a storage section, a convolution operation section, and a post-processing operation section. The storage section is configured to store a plurality of pieces of word data each including at least one of a piece of processing target data or a piece of weighting coefficient data, and is configured to be accessed in word data units. The convolution operation section is configured to perform a convolution operation on the basis of the piece of processing target data and the piece of weighting coefficient data. The post-processing operation section is configured to perform a predetermined operation on the basis of an operation result of the convolution operation and store the operation result as the piece of processing target data in the storage section. The piece of processing target data includes a plurality of pieces of data each including a plurality of pieces of bit data. The plurality of pieces of word data includes a piece of second word data including two or more pieces of most significant bit data provided side by side, the two or more pieces of most significant bit data being in two or more pieces of data among the plurality of pieces of data.

In the first information processing device according to one embodiment of the present disclosure, the storage section stores the plurality of pieces of word data. The plurality of pieces of word data each includes at least one of the piece of processing target data or the piece of weighting coefficient data. The storage section is accessed in word data units. The convolution operation section performs the convolution operation on the basis of the piece of processing target data and the piece of weighting coefficient data. The post-processing operation section performs the predetermined operation on the basis of the operation result of the convolution operation, and stores the operation result as the piece of processing target data in the storage section. The piece of weighting coefficient data includes the plurality of pieces of coefficient data each including the plurality of pieces of bit data. The plurality of pieces of word data includes the piece of first word data including the two or more pieces of most significant bit data provided side by side, the two more pieces of most significant bit data being in the two or more pieces of coefficient data among the plurality of pieces of coefficient data.

In the first information processing device according to one embodiment of the present disclosure, the storage section stores the plurality of pieces of word data. The plurality of pieces of word data each includes at least one of the piece of processing target data or the piece of weighting coefficient data. The storage section is accessed in word data units. The convolution operation section performs the convolution operation on the basis of the piece of processing target data and the piece of weighting coefficient data. The post-processing operation section performs the predetermined operation on the basis of the operation result of the convolution operation, and stores the operation result as the piece of processing target data in the storage section. The piece of processing target data includes the plurality of pieces of data each including the plurality of pieces of bit data. The plurality of pieces of word data includes the piece of second word data including the two or more pieces of most significant bit data provided side by side, the two or more pieces of most significant bit data being in the two or more pieces of data among the plurality of pieces of data.

### BRIEF DESCRIPTION OF DRAWINGS

FIG. 1 is a block diagram illustrating a configuration example of an imaging device according to an embodiment of the present disclosure.

FIG. 2 is a block diagram illustrating a configuration example of an imaging section illustrated in FIG. 1.

FIG. 3 is an explanatory diagram illustrating an operation example of a recognition processor illustrated in FIG. 1.

FIG. 4 is an explanatory diagram illustrating an operation example of a point-wise convolution operation to be performed by a convolution operation section illustrated in FIG. 1.

FIG. 5 is an explanatory diagram illustrating an operation example of a depth-wise convolution operation to be performed by the convolution operation section illustrated in FIG. 1.

FIG. 6 is another explanatory diagram illustrating an operation example of the recognition processor illustrated in FIG. 1.

FIG. 7 is an explanatory diagram illustrating a piece of data to be supplied to the convolution operation section illustrated in FIG. 1.

FIG. 8 is an explanatory diagram illustrating an example of a data arrangement of the piece of data illustrated in FIG. 7 in a memory.

FIG. 9 is an explanatory diagram illustrating another example of the data arrangement of the piece of data illustrated in FIG. 7 in the memory.

FIG. 10 is an explanatory diagram illustrating another example of the data arrangement of the piece of data illustrated in FIG. 7 in the memory.

FIG. 11 is an explanatory diagram illustrating an example of a piece of weighting coefficient data to be supplied to the convolution operation section illustrated in FIG. 1.

FIG. 12 is an explanatory diagram illustrating an example of a data arrangement of the piece of weighting coefficient data illustrated in FIG. 11 in the memory.

FIG. 13 is an explanatory diagram illustrating another example of the piece of weighting coefficient data to be supplied to the convolution operation section illustrated in FIG. 1.

FIG. 14 is an explanatory diagram illustrating an example of a data arrangement of the piece of weighting coefficient data illustrated in FIG. 13 in the memory.

FIG. 15 is an explanatory diagram illustrating a specific example of the data arrangement illustrated in FIG. 14.

FIG. 16 is an explanatory diagram illustrating another specific example of the data arrangement illustrated in FIG. 14.

FIG. 17 is an explanatory diagram illustrating an example of a piece of data in a bit-wise binary format.

FIG. 18 is another explanatory diagram illustrating an example of the piece of data in the bit-wise binary format.

FIG. 19 is a block diagram illustrating a configuration example of the convolution operation section illustrated in FIG. 1.

FIG. 20 is an explanatory diagram illustrating an operation example of the convolution operation section illustrated in FIG. 19.

FIG. 21 is an explanatory diagram illustrating another operation example of the convolution operation section illustrated in FIG. 19.

FIG. 22 is a block diagram illustrating a configuration example of a post-processing operation section illustrated in FIG. 1.

FIG. 23 is an explanatory diagram illustrating an operation example of the post-processing operation section illustrated in FIG. 22.

FIG. 24 is a block diagram illustrating another configuration example of the post-processing operation section illustrated in FIG. 1.

FIG. 25 is an explanatory diagram illustrating an example in which a model parameter is written to the imaging device illustrated in FIG. 1.

FIG. 26 is an explanatory diagram illustrating an implementation example of the imaging device illustrated in FIG. 1.

FIG. 27 is an explanatory diagram illustrating a layout example of respective circuits on semiconductor substrates illustrated in FIG. 26.

FIG. 28 is another explanatory diagram illustrating an operation example of the recognition processor illustrated in FIG. 1.

FIG. 29 is an explanatory diagram illustrating an example of memory access to the memory illustrated in FIG. 1.

FIG. 30 is another explanatory diagram illustrating an example of memory access to the memory illustrated in FIG. 1.

FIG. 31 is another explanatory diagram illustrating an example of memory access to the memory illustrated in FIG. 1.

FIG. 32 is an explanatory diagram illustrating an example of memory access according to a reference example.

FIG. 33 is a block diagram illustrating a configuration example of an imaging device according to a modification example.

FIG. 34 is an explanatory diagram illustrating another example of the piece of data in the bit-wise binary format according to another modification example.

FIG. 35 is another explanatory diagram illustrating another example of the piece of data in the bit-wise binary format according to another modification example.

FIG. 36 is an explanatory diagram illustrating a configuration example of a pixel array illustrated in FIG. 1.

FIG. 37 is an explanatory diagram illustrating another configuration example of a pixel array according to another modification example.

FIG. 38 is an explanatory diagram illustrating another configuration example of a pixel array according to another modification example.

FIG. 39 is an explanatory diagram illustrating another configuration example of a pixel array according to another modification example.

FIG. 40 is an explanatory diagram illustrating another configuration example of a pixel array according to another modification example.

FIG. 41 is a block diagram illustrating a configuration example of a recognition processing device according to another modification example.

### MODES FOR CARRYING OUT THE INVENTION

In the following, some embodiments of the present disclosure are described in detail with reference to the drawings.

### Embodiment

### Configuration Example

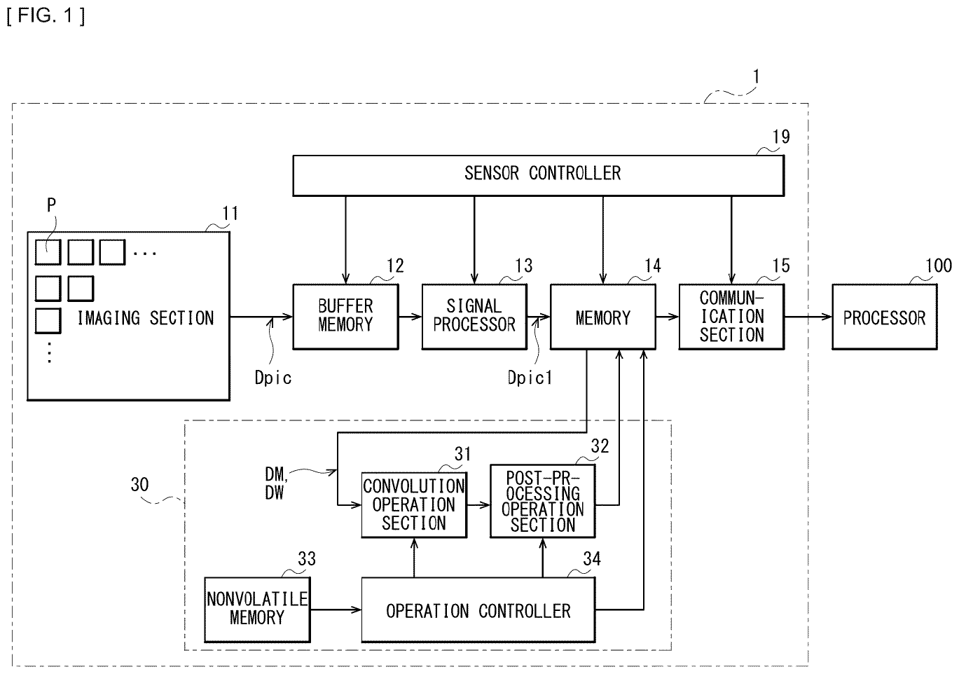

FIG. 1 illustrates a configuration example of an information processing device (an imaging device 1) according to an embodiment. The imaging device 1 images a subject and performs recognition processing on the basis of a result of the imaging. The imaging device 1 includes an imaging section 11, a buffer memory 12, a signal processor 13, a memory 14, a communication section 15, a sensor controller 19, and a recognition processor 30.

The imaging section 11 is configured to perform an imaging operation for imaging a subject and output a result of the imaging as a piece of image data Dpic.

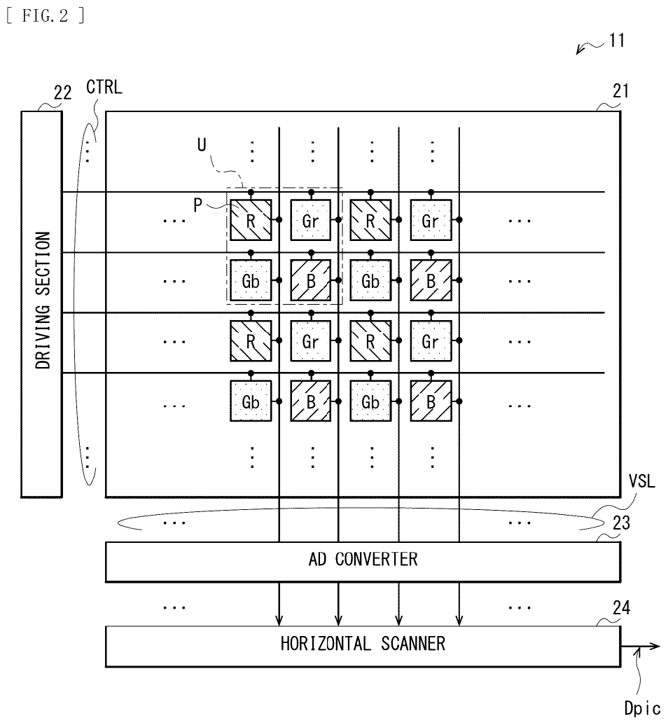

FIG. 2 illustrates a configuration example of the imaging section 11. The imaging section 11 includes a pixel array 21, a driving section 22, an AD (Analog to Digital) converter 23, and a horizontal scanner 24.

The pixel array 21 includes a plurality of control lines CTRL, a plurality of signal lines VSL, and a plurality of light-receiving pixels P. The plurality of control lines CTRL is provided to extend in a lateral direction (a horizontal direction) in FIG. 2. The plurality of control lines CTRL each has one end coupled to the driving section 22. The plurality of signal lines VSL is provided to extend in a longitudinal direction (a vertical direction) in FIG. 2. The plurality of signal lines VSL each has one end coupled to the AD converter 23. The plurality of light-receiving pixels P is arranged in a matrix in the pixel array 21. The plurality of light-receiving pixels P includes a light-receiving pixel provided with a red (R) color filter, light-receiving pixels provided with green (Gr and Gb) color filters, and a light-receiving pixel provided with a blue (B) color filter. In the pixel array 21, the plurality of light-receiving pixels P is arranged in units U of four light-receiving pixels P. The four light-receiving pixels P in the unit U are arranged in two rows and two columns. In this unit U, the light-receiving pixel P provided with the red (R) color filter is provided at the upper left, the light-receiving pixel P provided with the green (Gr) color filter is provided at the upper right, the light-receiving pixel P provided with the green (Gb) color filter is provided at the lower left, and the light-receiving pixel P provided with the blue (B) color filter is provided at the lower right. In this way, the light-receiving pixels P are arranged in what is called a Bayer arrangement. Each of the plurality of light-receiving pixels P is coupled to the control line CTRL, and is coupled to the signal line VSL. The light-receiving pixels P each operate on the basis of a control signal supplied via the control line CTRL, and each output a pixel signal including a pixel voltage corresponding to an amount of received light to the signal line VSL.

The AD converter 23 is configured to convert pixel voltages corresponding to the amount of received light into pixel values corresponding to the amount of received light by performing AD conversion on the basis of a plurality of pixel signals supplied from the pixel array 21 via the plurality of signal lines VSL. The AD converter 23 converts pixel voltages related to the light-receiving pixels P for one row supplied from the pixel array 21 into pixel values related to the light-receiving pixels P for one row, and supplies the pixel values related to the light-receiving pixels P for one row to the horizontal scanner 24. The AD converter 23 repeats this operation to thereby generate pixel values of all the light-receiving pixels P in the pixel array.

The horizontal scanner 24 is configured to sequentially output the pixel values related to the light-receiving pixels P for one row supplied from the AD converter 23 by performing a scanning operation. The horizontal scanner 24 repeats this operation to thereby output the pixel values of all the light-receiving pixels P in the pixel array 21 as the piece of image data Dpic.

With such a configuration, the imaging section 11 performs an imaging operation and outputs a result of the imaging as the piece of image data Dpic.

The buffer memory 12 (FIG. 1) is configured to temporarily store the piece of image data Dpic supplied from the imaging section 11.

The signal processor 13 is configured to generate a piece of image data Dpic1 by performing, for example, various types of image processing such as noise removal processing or black level adjustment processing on the piece of image data Dpic supplied from the buffer memory 12.

The memory 14 is configured to store a piece of data to be processed in the imaging device 1. The memory 14 includes, for example, a DRAM (Dynamic Random Access Memory), a SRAM (Static Random Access Memory), or the like. The memory 14 stores, for example, the piece of image data Dpic1 supplied from the signal processor 13. In addition, the memory 14 stores a piece of data DM (to be described later) and a piece of weighting coefficient data DW (to be described later) that are to be used when the recognition processor 30 performs recognition processing. Thereafter, the memory 14 supplies the piece of image data Dpic1 and a piece of data representing a processing result of the recognition processing to the communication section 15.

The recognition processor 30 is configured to perform recognition processing using a neural network on the basis of a piece of data stored in the memory 14.

The communication section 15 is configured to transmit, to a processor 100, the piece of image data and the piece of data representing the processing result of the recognition processing that are supplied from the memory 14.

The sensor controller 19 is configured to control operations of the buffer memory 12, the signal processor 13, the memory 14, and the communication section 15.

The processor 100 is configured to perform predetermined processing on the basis of the piece of image data and the processing result of the recognition processing that are supplied from the imaging device 1.

### Recognition Processor 30

The recognition processor 30 includes a convolution operation section 31, a post-processing operation section 32, a nonvolatile memory 33, and an operation controller 34.

The convolution operation section 31 is configured to perform a convolution operation CONV using the neural network on the basis of an instruction from the operation controller 34. The convolution operation section 31 performs a convolution operation on the basis of the piece of data DM and the piece of weighting coefficient data DW that are supplied from the memory 14.

The post-processing operation section 32 is configured to perform a predetermined post-processing operation POST including a quantization operation, transposition processing to be described later, and the like on a result of the operation by the convolution operation section 31 on the basis of an instruction from the operation controller 34. Thereafter, the post-processing operation section 32 stores a result of processing as the piece of data DM in the memory 14.

The nonvolatile memory 33 includes, for example, a flash memory, and is configured to store a model parameter of the neural network to be used in recognition processing in the recognition processor 30. The model parameter of the neural network is created with use of, for example, a software development kit (SDK: Software Development Kit), and is stored in this nonvolatile memory 33 in advance.

The operation controller 34 is configured to control recognition processing in the recognition processor 30 by controlling operations of the convolution operation section 31 and the post-processing operation section 32, on the basis of the model parameter supplied from the nonvolatile memory 33. The operation controller 34 stores the piece of weighting coefficient data DW included in the model parameter in the memory 14. In addition, the operation controller 34 also performs a function of supplying a write address for writing the piece of data DM and the piece of weighting coefficient data DW to the memory 14, and a readout address for reading the piece of data DM and the piece of weighting coefficient data DW from the memory 14.

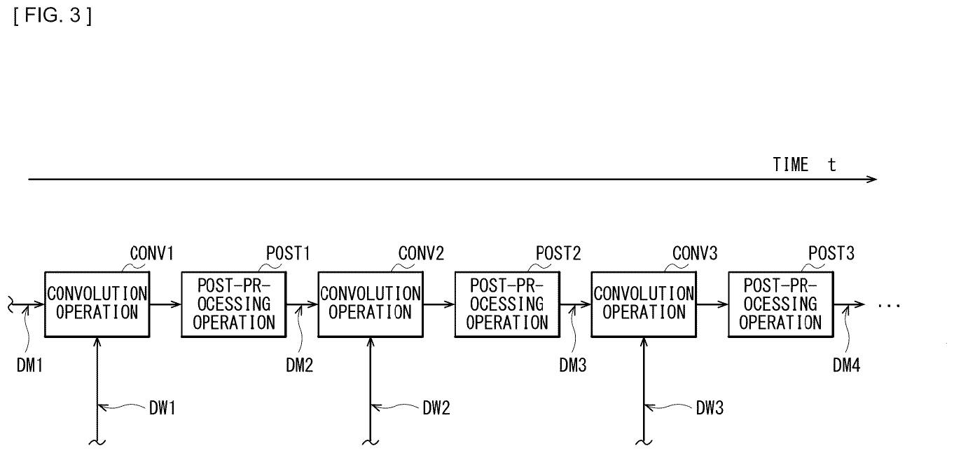

FIG. 3 illustrates an operation example of the recognition processor 30. In the recognition processor 30, the convolution operation section 31 and the post-processing operation section 32 alternately perform operations. Specifically, in this example, the convolution operation section 31 first performs, on the piece of data DM (a piece of data DM1) supplied from the memory 14, a convolution operation CONV1 using the piece of weighting coefficient data DW (a piece of weighting coefficient data DW1) supplied from the memory 14. The piece of data DM1 in this example is the piece of image data Dpic1 supplied from the memory 14. The post-processing operation section 32 performs a post-processing operation POST1 on an operation result of the convolution operation CONV1, and writes the operation result as the piece of data DM (a piece of data DM2) to the memory 14. Next, the convolution operation section 31 performs, on the piece of data DM2 supplied from the memory 14, a convolution operation CONV2 using the piece of weighting coefficient data DW (a piece of weighting coefficient data DW2) supplied from the memory 14. The post-processing operation section 32 performs a post-processing operation POST2 on an operation result of the convolution operation CONV2, and writes the operation result as the piece of data DM (a piece of data DM3) to the memory 14. Next, the convolution operation section 31 performs, on the piece of data DM3 supplied from the memory 14, a convolution operation CONV3 using the piece of weighting coefficient data DW (a piece of weighting coefficient data DW3) supplied from the memory 14. The post-processing operation section 32 performs a post-processing operation POST3 on an operation result of the convolution operation CONV3, and writes the operation result as a piece of data DM4 to the memory 14. The same applies thereafter. The convolution operation section 31 and the post-processing operation section 32 alternately perform the operations in such a manner.

The convolution operation section 31 is configured to perform two types of convolution operations CONV. Specifically, the convolution operation section 31 is configured to perform a point-wise convolution (Point-wise Convolution) operation CONVP and a depth-wise convolution (Depth-wise Convolution) operation CONVD.

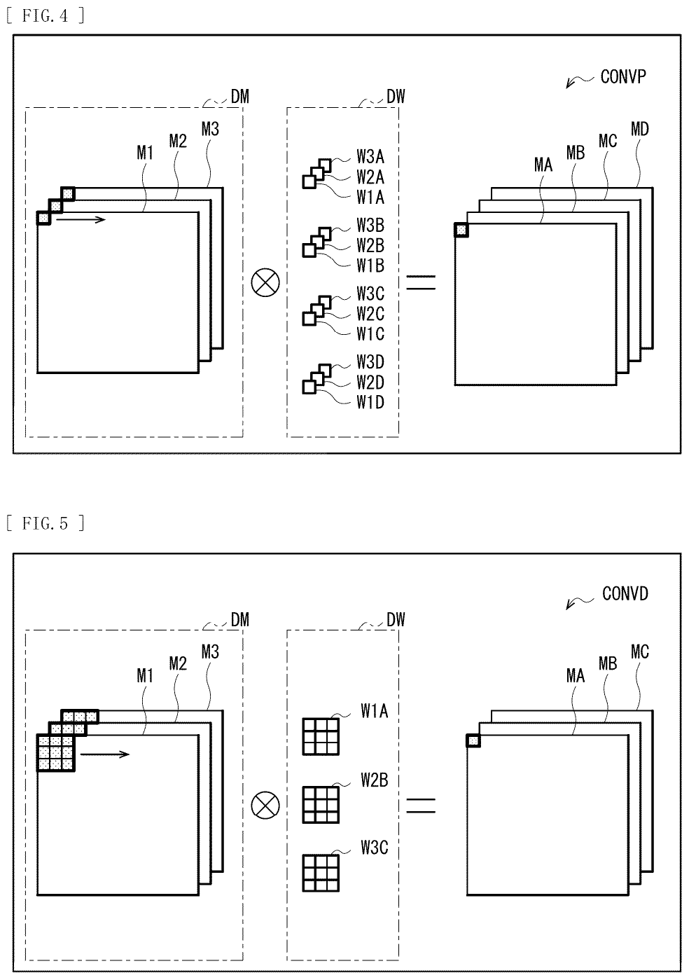

FIG. 4 illustrates an example of the point-wise convolution operation CONVP. The convolution operation section 31 performs this point-wise convolution operation CONVP using the piece of weighting coefficient data DW on the piece of data DM.

The piece of data DM in this example includes three pieces of map data M1, M2, and M3. That is, in this example, the piece of data DM includes pieces of data with three channels. For example, in a case where the first convolution operation CONV1 in FIG. 3 is the point-wise convolution operation CONVP, the piece of map data M1 is a piece of image data presenting a red (R) image, the piece of map data M2 is a piece of image data representing a green (G) image, and the piece of map data M3 is a piece of image data representing a blue (B) image.

The piece of weighting coefficient data DW in this example includes pieces of coefficient data W1A, W2A, W3A, W1B, W2B, W3B, W1C, W2C, W3C, W1D, W2D, and W3D. Each of the pieces of coefficient data W1A, W2A, W3A, W1B, W2B, W3B, W1C, W2C, W3C, W1D, W2D, and W3D is a 1×1 kernel including one (=1×1) piece of coefficient data. The pieces of coefficient data W1A, W1B, W1C, and W1D are associated with the piece of map data M1. The pieces of coefficient data W2A, W2B, W2C, and W2D are associated with the piece of map data M2. The pieces of coefficient data W3A, W3B, W3C, and W3D are associated with the piece of map data M3.

In the point-wise convolution operation CONVP, the convolution operation section 31 performs a convolution operation using the piece of coefficient data W1A on the piece of map data M1, performs a convolution operation using the piece of coefficient data W2A on the piece of map data M2, and performs a convolution operation using the piece of coefficient data W3A on the piece of map data M3, thereby generating a piece of map data MA. Specifically, for example, the convolution operation section 31 first sets a convolution operation region having a size of 1×1 on the far left in an uppermost row in each of the pieces of map data M1, M2, and M3. Thereafter, the convolution operation section 31 performs a multiplication of a piece of data (a hatched part) in the convolution operation region of the piece of map data M1 by the piece of coefficient data W1A, performs a multiplication of a piece of data (a hatched part) in the convolution operation region of the piece of map data M2 by the piece of coefficient data W2A, performs a multiplication of a piece of data (a hatched part) in the convolution operation region of the piece of map data M3 by the piece of coefficient data W3A, and adds results of these multiplications together, thereby calculating a piece of data (a hatched part) on the far left in the uppermost row in the piece of map data MA. Next, the convolution operation section 31 shifts the convolution operation region in each of the pieces of map data M1, M2, and M3 to the right by one. Thereafter, the convolution operation section 31 performs a multiplication of a piece of data in the convolution operation region of the piece of map data M1 by the piece of coefficient data W1A, performs a multiplication of a piece of data in the convolution operation region of the piece of map data M2 by the piece of coefficient data W2A, performs a multiplication of a piece of data in the convolution operation region of the piece of the piece of map data M3 by the piece of coefficient data W3A, and adds results of these multiplications together, thereby calculating the second piece of data from the left in the uppermost row in the piece of map data MA. After this, the convolution operation section 31 sequentially changes the convolution operation regions in the pieces of map data M1, M2, and M3, and performs a similar operation. Thus, the convolution operation section 31 generates the piece of map data MA.

In this way, in the point-wise convolution operation CONVP, the convolution operation section 31 performs, on the pieces of map data M1 to M3 with three channels, the convolution operation using 1×1 kernels (the pieces of coefficient data W1A, W2A, and W3A) with three channels, thereby generating the piece of map data MA.

Likewise, the convolution operation section 31 performs a convolution operation using the piece of coefficient data W1B on the piece of map data M1, performs a convolution operation using the piece of coefficient data W2B on the piece of map data M2, and performs a convolution operation using the piece of coefficient data W3B on the piece of map data M3, thereby generating a piece of map data MB. The convolution operation section 31 performs a convolution operation using the piece of coefficient data W1C on the piece of map data M1, performs a convolution operation using the piece of coefficient data W2C on the piece of map data M2, and performs a convolution operation using the piece of coefficient data W3C on the piece of map data M3, thereby generating a piece of map data MC. The convolution operation section 31 a convolution operation using the piece of coefficient data W1D on the piece of map data M1, performs a convolution operation using the piece of coefficient data W2D on the piece of map data M2, and performs a convolution operation using the piece of coefficient data W3D on the piece of map data M3, thereby generating a piece of map data MD. Thus, the convolution operation section 31 generates pieces of data with four channels in this example.

FIG. 5 illustrates an example of the depth-wise convolution operation CONVD. The convolution operation section 31 performs this depth-wise convolution operation CONVD using the piece of weighting coefficient data DW on the piece of data DM.

The piece of data DM in this example includes three pieces of map data M1, M2, and M3, as with a case of the point-wise convolution operation CONVP. That is, in this example, the piece of data DM includes pieces of data with three channels. For example, in a case where the first convolution operation CONV1 in FIG. 3 is this depth-wise convolution operation CONVD, the piece of map data M1 is a piece of image data representing a red (R) image, the piece of map data M2 is a piece of image data representing a green (G) image, and the piece of map data M3 is a piece of image data representing a blue (B) image.

The piece of weighting coefficient data DW in this example includes pieces of coefficient data W1A, W2B, and W3C. Each of the pieces of coefficient data W1A, W2B, and W3C is a 3×3 kernel including nine (=3×3) pieces of coefficient data. The piece of coefficient data W1A is associated with the piece of map data M1, the piece of coefficient data W2B is associated with the piece of map data M2, and the piece of coefficient data W3C is associated with the piece of map data M3.

In the depth-wise convolution operation CONVD, the convolution operation section 31 performs a convolution operation using the piece of coefficient data W1A on the piece of map data M1, thereby generating the piece of map data MA. Specifically, for example, the convolution operation section 31 first sets a convolution operation region having a size of 3×3 at the upper left in the piece of map data M1. Thereafter, the convolution operation section 31 performs multiplications of nine pieces of data (hatched parts) in the convolution operation region of the piece of map data M1 by the respective nine pieces of data in the piece of coefficient data W1A and adds results of these multiplications together, thereby calculating a piece of data (a hatched part) on the far left in the uppermost row in the piece of map data MA. Next, the convolution operation section 31 shifts the convolution operation region in the piece of map data M1 to the right by one. Thereafter, the convolution operation section 31 performs multiplications of nine pieces of data in the convolution operation region of the piece of map data M1 by the respective nine pieces of data in the piece of coefficient data W1A and adds results of these multiplications together, thereby calculating the second piece of data form the left in the uppermost row in the piece of map data MA. After this, the convolution operation section 31 sequentially changes the convolution operation region in the piece of map data M1, and performs a similar operation. Thus, the convolution operation section 31 generates the piece of map data MA.

In this way, in the depth-wise convolution operation CONVD, the convolution operation section 31 performs, on the piece of map data M1 with one channel, the convolution operation using the 3×3 kernels (the piece of coefficient data W1A) with one channel, thereby generating the piece of map data MA.

Likewise, the convolution operation section 31 performs a convolution operation using the piece of coefficient data W2B on the piece of map data M2, thereby generating the piece of map data MB. The convolution operation section 31 performs a convolution operation using the piece of coefficient data W3C on the piece of map data M3, thereby generating the piece of map data MC.

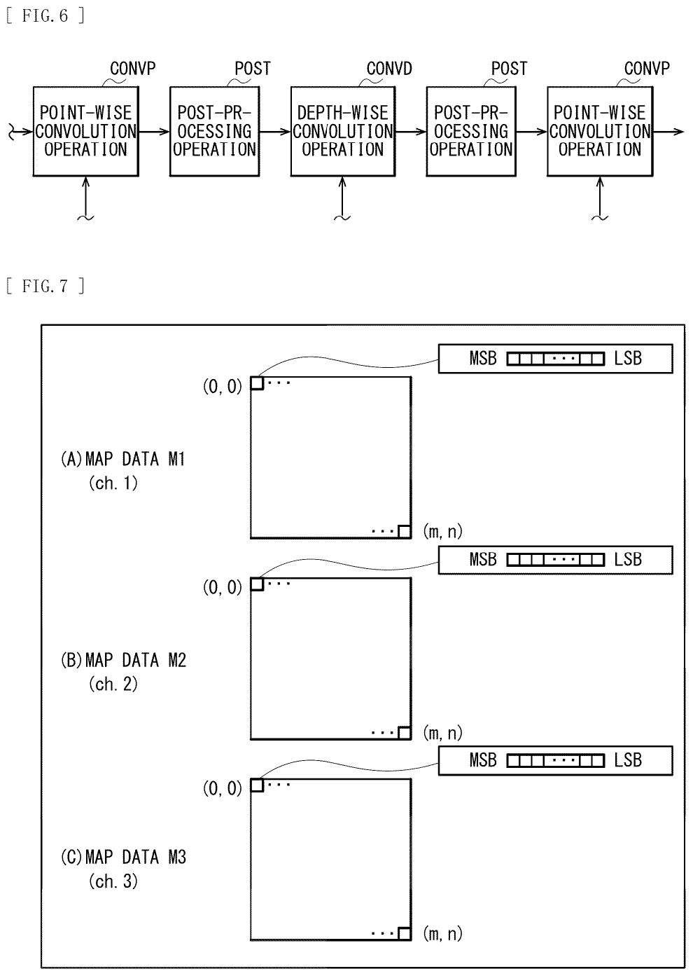

FIG. 6 illustrates an operation example of the convolution operation section 31. The convolution operation section 31 alternately performs the point-wise convolution operation CONVP and the depth-wise convolution operation CONVD, for example, as illustrated in FIG. 6. This makes it possible to perform an operation similar to what is called a 2D convolution (2D Convolution) operation in which a convolution operation is performed using a three-dimensional kernel. The convolution operation section 31 combines the point-wise convolution operation CONVP and the depth-wise convolution operation CONVD, which makes it possible to reduce an operation amount, as compared with a case where the 2D convolution operation is performed. Thus, it is possible to configure the convolution operation section 31 by low-resource hardware.

### Data Arrangement of Piece of Data DM

Next, description is given of a data arrangement, in the memory 14, of the piece of data DM to be inputted to the convolution operation section 31. First, description is given of a case where the convolution operation section 31 performs the point-wise convolution operation CONVP, and description is then given of a case where the convolution operation section 31 performs the depth-wise convolution operation CONVD.

FIG. 7 illustrates an example of three pieces of map data M1 to M3 included in the piece of data DM to be inputted to the convolution operation section 31. The piece of map data M1 corresponding to a first channel (ch.1) has m pieces of data in the lateral direction and n pieces of data in the longitudinal direction, as illustrated in FIG. 7. The position of a piece of data in an upper left corner is (0, 0), and the position of a piece of data in a lower right corner is (m, n). Each piece of data includes a plurality of pieces of bit data from a most significant bit (MSB; Most Significant Bit) to a least significant bit (LSB; Least Significant Bit). The same applies to the piece of map data M2 corresponding to a second channel (ch.2), and the same applies to the piece of map data M3 corresponding to a third channel (ch.3).

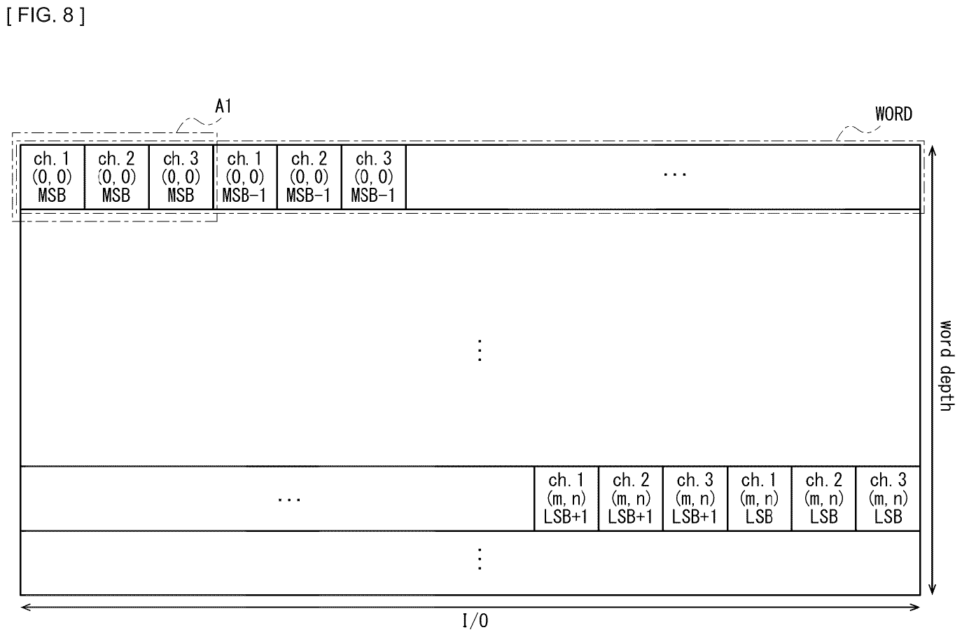

FIG. 8 illustrates an example of the data arrangement, in the memory 14, of the piece of data DM to be inputted in a case where the convolution operation section 31 performs the point-wise convolution operation CONVP (FIG. 4). In FIG. 8, pieces of data for one row constitute a piece of word data WORD. The memory 14 is accessed in word data WORD units. A data width of the piece of word data WORD is, for example, 128 bits. It is to be noted that the data width of the piece of word data WORD is not limited thereto, and may be, for example, 32 bits, 64 bits, or 256 bits.

In a case where the convolution operation section 31 performs the point-wise convolution operation CONVP, the respective pieces of bit data in the piece of data DM illustrated in FIG. 7 are arranged in the memory 14 as illustrated in FIG. 8. For example, in an uppermost piece of word data WORD, the pieces of bit data are arranged in order, from the left, of the most significant bit (MSB) at (0, 0) of the piece of map data M1 corresponding to the first channel (ch.1), the most significant bit (MSB) at (0, 0) of the piece of map data M2 corresponding to the second channel (ch.2), the most significant bit (MSB) at (0, 0) of the piece of map data M3 corresponding to the third channel (ch.3), the second bit (MSB-1) from the most significant bit at (0, 0) of the piece of map data M1 corresponding to the first channel (ch.1), the second bit (MSB-1) from the most significant bit at (0, 0) of the piece of map data M2 corresponding to the second channel (ch.2), and the second bit (MSB-1) from the most significant bit at (0, 0) of the piece of map data M3 corresponding to the third channel (ch.3). Thus, in the uppermost piece of word data WORD, pieces of bit data related to three most significant bits are provided side by side as illustrated in a portion A1.

As illustrated in FIG. 4, the convolution operation section 31 performs a multiplication of a piece of data (for example, a hatched part) in the convolution operation region of the piece of map data M1 corresponding to the first channel (ch.1) by the piece of coefficient data W1A, performs a multiplication of a piece of data (for example, a hatched part) in the convolution operation region of the piece of map data M2 corresponding to the second channel (ch.2) by the piece of coefficient data W2A, performs a multiplication of a piece of data (for example, a hatched part) in the convolution operation region of the piece of map data M3 corresponding to the third channel (ch.3) by the piece of coefficient data W4A, and adds results of these multiplications together. Thus, in the data arrangement in the memory 14, as illustrated in FIG. 8, all pieces of bit data from the most significant bit to the least significant bit at (0, 0) of each of the piece of map data M1 corresponding to the first channel (ch.1), the piece of map data M2 corresponding to the second channel (ch.2), and the piece of map data M3 corresponding to the third channel (ch.3) are arranged in order from the most significant bit.

The convolution operation section 31 uses the piece of data DM having the data arrangement illustrated in FIG. 8, thereby making it possible to perform the point-wise convolution operation CONVP while changing the piece of bit data to be used among all the pieces of bit data from the most significant bit to the least significant bit. Specifically, the convolution operation section 31 is configured to perform the point-wise convolution operation CONVP using all the pieces of bit data from the most significant bit to the least significant bit in the piece of data DM. In this case, the convolution operation section 31 is configured to perform the convolution operation with high accuracy. In addition, the convolution operation section 31 is configured to perform the point-wise convolution operation CONVP using only pieces of bit data for several bits from the most significant bit among all the pieces of bit data from the most significant bit to the least significant bit in the piece of data DM. In this case, in the imaging device 1, it is possible to reduce the number of times of access to the memory 14, which makes it possible to reduce power consumption.

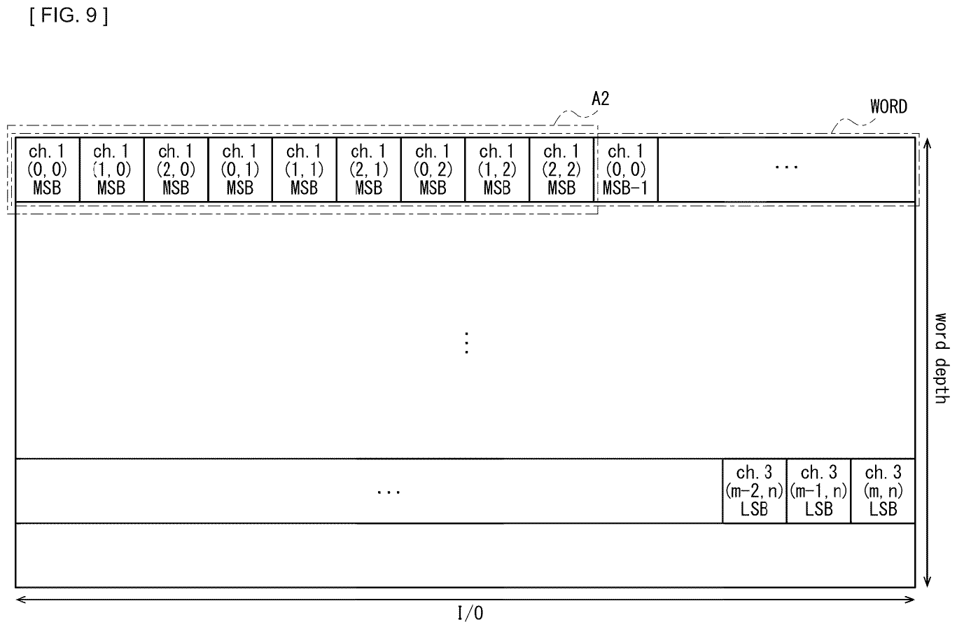

FIG. 9 illustrates an example of the data arrangement, in the memory 14, of the piece of data DM to be inputted in a case where the convolution operation section 31 performs the depth-wise convolution operation CONVD (FIG. 5). In FIG. 9, pieces of data for one row constitute the piece of word data WORD.

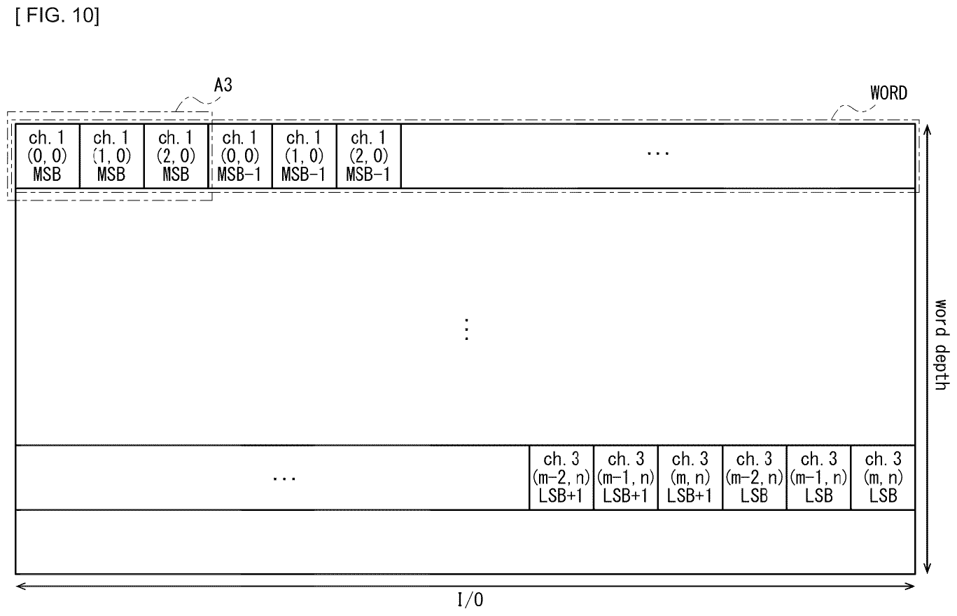

In a case where the convolution operation section 31 performs the depth-wise convolution operation CONVD, the respective pieces of bit data in the piece of data DM illustrated in FIG. 7 are arranged in the memory 14 as illustrated in FIG. 10 in this example. For example, in an uppermost piece of word data WORD, the pieces of bit data are arranged in order, from the left, of the most significant bit (MSB) at (0, 0), the most significant bit (MSB) at (1, 0), the most significant bit (MSB) at (2, 0), the most significant bit (MSB) at (0, 1), the most significant bit (MSB) at (1, 1), the most significant bit (MSB) at (2, 1), the most significant bit (MSB) at (0, 2), the most significant bit (MSB) at (1, 2), the most significant bit (MSB) at (2, 2), and the second bit (MSB-1) from the most significant bit at (0, 0) in the piece of map data M1 corresponding to the first channel (ch.1). Thus, in the uppermost piece of word data WORD, pieces of bit data related to nine most significant bits are provided side by side as illustrated in a portion A2.

As illustrated in FIG. 5, the convolution operation section 31 performs multiplications of nine pieces of data (for example, hatched parts) in the convolution operation region of the piece of map data M1 corresponding to the first channel (ch.1) by respective nine pieces of data in the piece of coefficient data W1A and adds results of these multiplications together. Thus, in the data arrangement in the memory 14, as illustrated in FIG. 9, in this example, all the pieces of bit data from the most significant bit to the least significant bit at (0, 0) to (2, 2) of the piece of map data M1 corresponding to the first channel (ch.1) are arranged in order from the most significant bit.

FIG. 10 illustrates another example of the data arrangement, in the memory 14, of the piece of data DM to be inputted in a case where the convolution operation section 31 performs the depth-wise convolution operation CONVD (FIG. 5). In FIG. 10, pieces of data for one row constitute the piece of word data WORD.

In a case where the convolution operation section 31 performs the depth-wise convolution operation CONVD, the respective pieces of bit data in the piece of data DM illustrated in FIG. 7 are arranged in the memory 14 as illustrated in FIG. 10. For example, in an uppermost piece of word data WORD, the pieces of bit data are arranged in order, from the left, of the most significant bit (MSB) at (0, 0), the most significant bit (MSB) at (1, 0), the most significant bit (MSB) at (2, 0), the second bit (MSB-1) from the most significant bit at (0, 0 ), the second bit (MSB-1) from the most significant bit at (1, 0), and the second bit (MSB-1) from the most significant bit at (2, 0) in the piece of map data M1 corresponding to the first channel (ch.1). Thus, in the uppermost piece of word data WORD, pieces of bit data related to three most significant bits are provided side by side as illustrated in a portion A3.

The convolution operation section 31 uses the piece of data DM having the data arrangement illustrated in FIG. 9 or 10, thereby making it possible to perform the depth-wise convolution operation CONVD while changing the piece of bit data to be used among all the pieces of bit data from the most significant bit to the least significant bit. Specifically, the convolution operation section 31 is configured to perform the depth-wise convolution operation CONVD using all the pieces of bit data from the most significant bit to the least significant bit in the piece of data DM. In this case, the convolution operation section 31 is configured to perform the convolution operation with high accuracy. In addition, the convolution operation section 31 is configured to perform the depth-wise convolution operation CONVD using only pieces of bit data for several bits from the most significant bit among all the pieces of bit data from the most significant bit to the least significant bit in the piece of data DM. In this case, in the imaging device 1, it is possible to reduce the number of times of access to the memory 14, which makes it possible to reduce power consumption.

### Data Arrangement of Piece of Weighting Coefficient Data DW

Next, description is given of a data arrangement, in the memory 14, of the piece of weighting coefficient data DW to be inputted to the convolution operation section 31. First, description is given of a case where the convolution operation section 31 performs the point-wise convolution operation CONVP, and description is then given of a case where the convolution operation section 31 performs the depth-wise convolution operation CONVD.

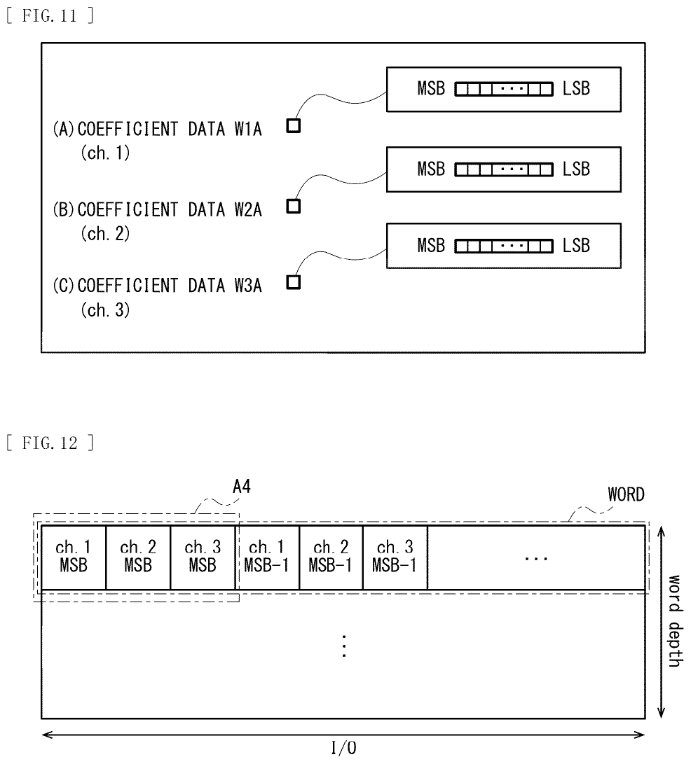

FIG. 11 illustrates an example of three pieces of coefficient data W1A, W2A, and W3A included in the piece of weighting coefficient data DW to be inputted in a case where the convolution operation section 31 performs the point-wise convolution operation CONVP (FIG. 4). The piece of coefficient data W1A corresponding to the first channel (ch.1) is 1×1 piece of data as illustrated in FIG. 11. This piece of data includes a plurality of pieces of bit data from the most significant bit to the least significant bit. The same applies to the piece of coefficient data W2A corresponding to the second channel (ch.2), and the same applies to the piece of coefficient data W3A corresponding to the third channel (ch.3). In addition, the same applies to three pieces of coefficient data W1B, W2B, and W3B, three pieces of coefficient data W1C, W2C, and W3C, and three pieces of coefficient data W1D, W2D, and W3D.

FIG. 12 illustrates an example of the data arrangement, in the memory 14, of the piece of weighting coefficient data DW to be inputted in a case where the convolution operation section 31 performs the point-wise convolution operation CONVP (FIG. 4). In FIG. 12, pieces of data for one row constitute the piece of word data WORD.

In a case where the convolution operation section 31 performs the point-wise convolution operation CONVP, respective pieces of bit data in the piece of weighting coefficient data DW including the pieces of coefficient data W1A, W2A, and W3A illustrated in FIG. 11 are arranged in the memory 14 as illustrated in FIG. 12. For example, in an uppermost piece of word data WORD, the pieces of bit data are arranged in order, from the left, of the most significant bit (MSB) of the piece of coefficient data W1A corresponding to the first channel (ch.1), the most significant bit (MSB) of the piece of coefficient data W2A corresponding to the second channel (ch.2), the most significant bit (MSB) of the piece of coefficient data W3A corresponding to the third channel (ch.3), the second bit (MSB-1) from the most significant bit of the piece of coefficient data W1A corresponding to the first channel (ch.1), the second bit (MSB-1) from the most significant bit of the piece of coefficient data W2A corresponding to the second channel (ch.2), and the second bit (MSB-1) from the most significant bit of the piece of coefficient data W3A corresponding to the third channel (ch.3). Thus, in the uppermost piece of word data WORD, pieces of bit data related to three most significant bits are provided side by side as illustrated in a portion A4.

The convolution operation section 31 uses the piece of weighting coefficient data DW having the data arrangement illustrated in FIG. 12, thereby making it possible to perform the point-wise convolution operation CONVP while changing the piece of bit data to be used among all the pieces of bit data from the most significant bit to the least significant bit. Specifically, the convolution operation section 31 is configured to perform the point-wise convolution operation CONVP using all the pieces of bit data from the most significant bit to the least significant bit in the piece of weighting coefficient data DW. In this case, the convolution operation section 31 is configured to perform the convolution operation with high accuracy. In addition, the convolution operation section 31 is configured to perform the point-wise convolution operation CONVP using only pieces of bit data for several bits from the most significant bit among all the pieces of bit data from the most significant bit to the least significant bit in the piece of weighting coefficient data DW. In this case, in the imaging device 1, it is possible to reduce the number of times of access to the memory 14, which makes it possible to reduce power consumption.

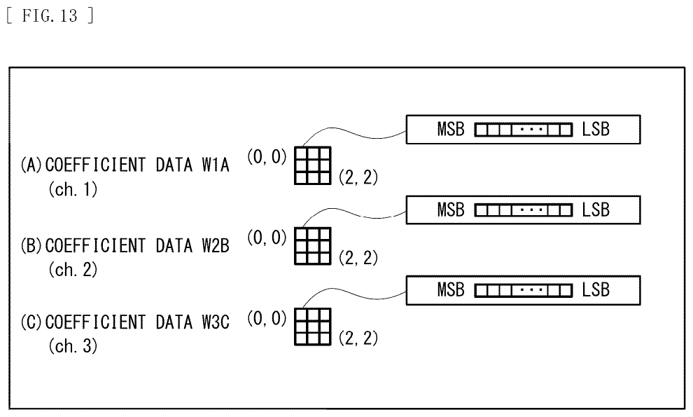

FIG. 13 illustrates an example of the piece of weighting coefficient data DW to be used in a case where the convolution operation section 31 performs the depth-wise convolution operation CONVD (FIG. 5). The piece of coefficient data W1A corresponding to the first channel (ch.1) includes 3×3 pieces of data as illustrated in FIG. 13. The position of a piece of data in an upper left corner is (0, 0), and the position of a piece of data in a lower right corner is (2, 2). Each of the pieces of data includes a plurality of pieces of bit data from the most significant bit to the least significant bit. The same applies to the piece of coefficient data W2B corresponding to the second channel (ch.2), and the same applies to the piece of coefficient data W3C corresponding to the third channel (ch.3).

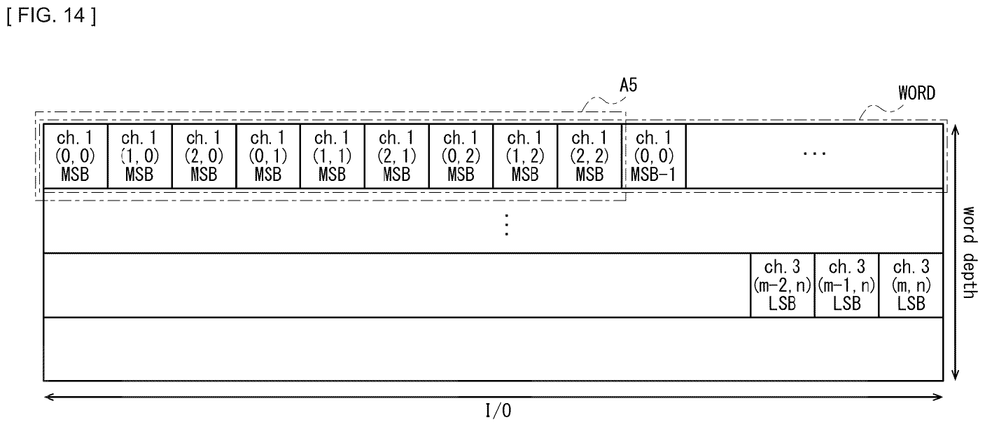

FIG. 14 illustrates an example of the data arrangement, in the memory 14, of the piece of weighting coefficient data DW to be inputted in a case where the convolution operation section 31 performs the depth-wise convolution operation CONVD (FIG. 5). In FIG. 14, pieces of data for one row constitute the piece of word data WORD.

In a case where the convolution operation section 31 performs the depth-wise convolution operation CONVD, respective pieces of bit data in the piece of coefficient data W1A illustrated in FIG. 13 are arranged in the memory 14 as illustrated in FIG. 14 in this example. For example, in an uppermost of word data WORD, the pieces of bit data are arranged in order, from the left, of the most significant bit (MSB) at (0, 0), the most significant bit (MSB) at (1, 0), the most significant bit (MSB) at (2, 0), the most significant bit (MSB) at (0, 1), the most significant bit (MSB) at (1, 1), the most significant bit (MSB) at (2, 1), the most significant bit (MSB) at (0, 2), the most significant bit (MSB) at (1, 2), the most significant bit (MSB) at (2, 2), and the second bit (MSB-1) from the most significant bit at (0, 0) in the piece of coefficient data W1A corresponding to the first channel (ch.1). Thus, in the uppermost piece of word data WORD, pieces of bit data related to nine most significant bits are provided side by side as illustrated in a portion A5.

The convolution operation section 31 uses the piece of weighting coefficient data DW having the data arrangement illustrated in FIG. 14, thereby making it possible to perform the depth-wise convolution operation CONVD while changing the piece of bit data to be used among all the pieces of bit data from the most significant bit to the least significant bit. Specifically, the convolution operation section 31 is configured to perform the depth-wise convolution operation CONVD using all the pieces of bit data from the most significant bit to the least significant bit in the piece of weighting coefficient data DW. In this case, the convolution operation section 31 is configured to perform the convolution operation with high accuracy. In addition, the convolution operation section 31 is configured to perform the depth-wise convolution operation CONVD using only pieces of bit data for several bits from the most significant bit among all the pieces of bit data from the most significant bit to the least significant bit in the piece of weighting coefficient data DW. In this case, in the imaging device 1, it is possible to reduce the number of times of access to the memory 14, which makes it possible to reduce power consumption.

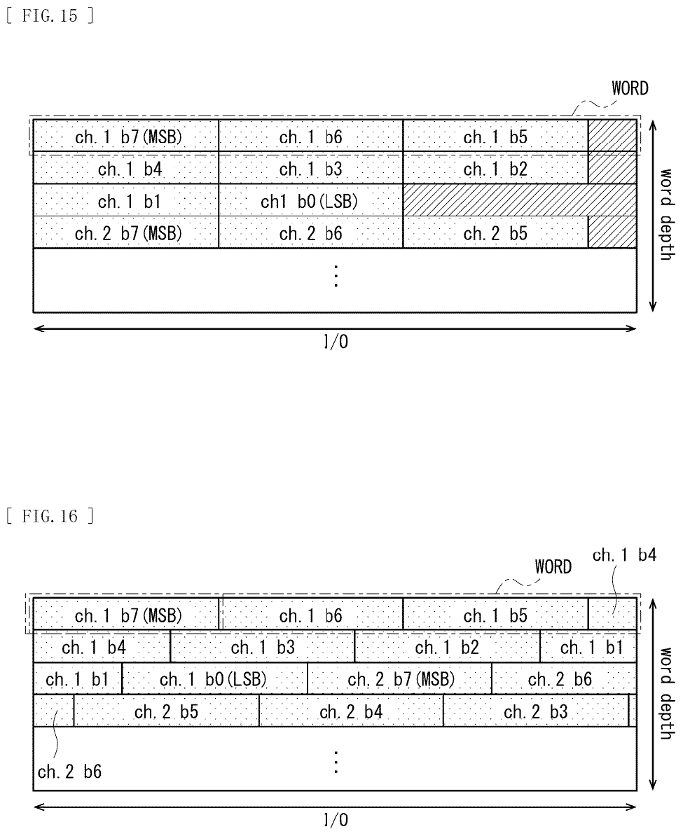

FIGS. 15 and 16 each illustrate a specific example of the data arrangement, in the memory 14, of the piece of weighting coefficient data DW illustrated in FIG. 14. In this example, each of the pieces of data in the piece of weighting coefficient data DW includes pieces of data of 8 bits, and includes bits b7, b6, . . . b0. The bit b7 is the most significant bit, and the bit b0 is the least significant bit. For description convenience, a bit width of the piece of word data WORD is 32 bits in this example.

As illustrated in FIG. 14, in the uppermost piece of word data WORD, nine pieces of bit data in the most significant bits (MSBs) in the piece of coefficient data W1A corresponding to the first channel (ch.1) are provided side by side. The symbol “ch.1 b7(MSB)” in FIGS. 15 and 16 corresponds to pieces of bit data in nine most significant bits (bit 7).

In an example in FIG. 15, the uppermost piece of word data WORD includes pieces of bit data in nine bits b7 (MSBs), pieces of bit data in nine bits b6, and pieces of bit data in nine bits b5 in the piece of coefficient data W1A corresponding to the first channel (ch.1). A rightmost shaded portion indicates a piece of invalid data. The second piece of word data WORD from the top includes pieces of bit data in nine bits b4, pieces of bit data in nine bits b3, and pieces of bit data in nine bits b2. The third piece of word data WORD from the top includes pieces of bit data in nine bits b1 and pieces of bit data in nine bits b0 (LSBs). The fourth piece of word data WORD from the top includes pieces of bit data in nine bits b7 (MSBs), pieces of bit data in nine bits b6, and pieces of bit data in nine bits b5 in the piece of coefficient data W2B corresponding to the second channel (ch.2).

In an example in FIG. 16, the uppermost piece of word data WORD includes pieces of bit data in nine bits b7 (MSBs), pieces of bit data in nine bits b6, pieces of bit data in nine bits b5, and a part of pieces of bit data in nine bits b4 in the piece of coefficient data W1A corresponding to the first channel (ch.1). The second piece of word data WORD from the top includes the remaining part of the pieces of bit data in the nine bits b4, pieces of bit data in nine bits b3, pieces of bit data in nine bits b2, and a part of pieces of bit data in nine bits b1. The third piece of word data WORD from the top includes the remaining part of the pieces of bit data in the nine bits b1 and pieces of bit data in nine bits b0 (LSBs), and pieces of bit data in nine bits b7 (MSBs) and a part of pieces of bit data in nine bits b6 in the piece of coefficient data W2B corresponding to the second channel (ch.2). For example, using the example in FIG. 16 makes it possible to reduce a memory usage of the memory 14.

### About Bit-wise Binary Quantization

In a case where the recognition processor 30 performs an operation, it is possible to use a piece of data in a bit-wise binary (BWB: Bit-wise Binary) format for each piece of data in the piece of data DM and the piece of weighting coefficient data DW. The piece of data in the bit-wise binary format is described, for example, in J. Suzuki, et al., “ProgressiveNN: Achieving Computational Scalability without Network Alteration by MSB-first Accumulative Computation,” CANDAR 2020, November 2020.

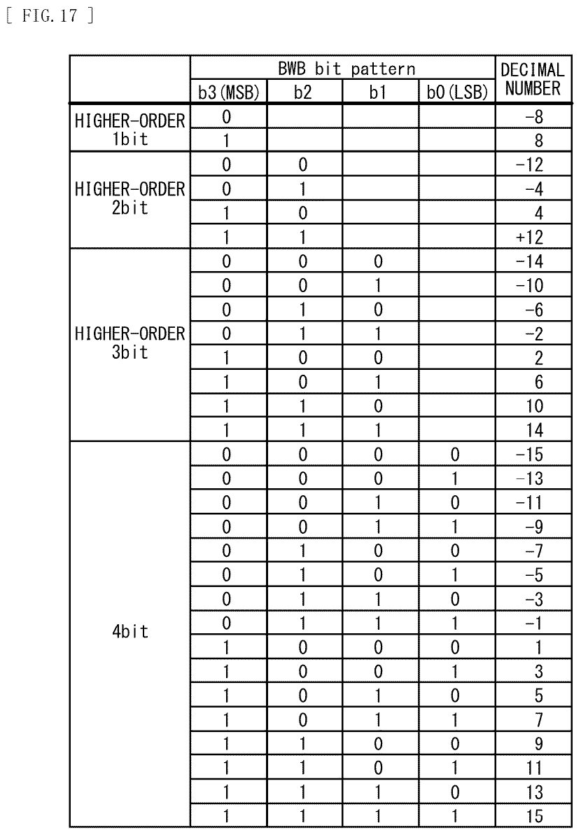

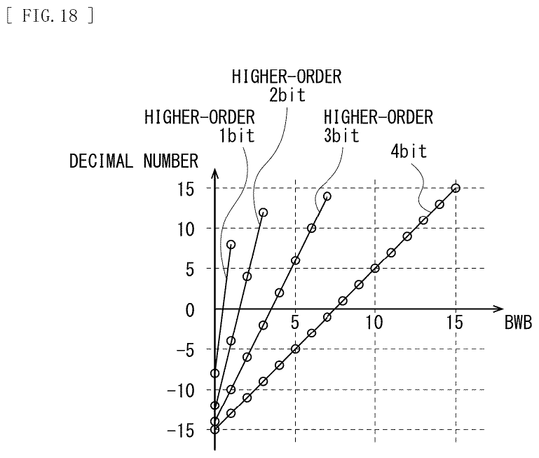

FIGS. 17 and 18 each illustrate an example of the piece of data in the bit-wise binary format. In this example, the piece of data in the bit-wise binary format includes pieces of data of 4 bits, and includes bits b3, b2, b1, and b0. The bit b3 is the most significant bit, and the bit b0 is the least significant bit.

In a case where the piece of data in the bit-wise binary format is converted into a decimal number, for example, a value “1” in the bit b3 is converted into “+8” (=2\hat{ }3), and a value “0” in the bit b3 is converted into “−8″” (=−2\hat{ }3). That is, “1” in binary number is converted into a positive value, and “0” in binary number is converted into a negative value. A value “1” in the bit b2 is converted into “+4” (=2\hat{ }2), and a value “0” in the bit b2 is converted into “−4” (=−2\hat{ }2). A value “1” in the bit b1 is converted into “+2” (=2\hat{ }1), and a value “0” in the bit b1 is converted into “−2” (=−2\hat{ }1). A value “1” in the bit b0 is converted into “+1” (=2\hat{ }0), and a value “0” in the bit b0 is converted into “−1” (=−2\hat{ }0).

FIG. 17 illustrates a correspondence between the piece of data (in binary number) in the bit-wise binary format and a decimal number. For example, a value “0000” corresponds to “−15” (=−8−4−2−1). For example, a value “0111” corresponds to “−1” (=−8+4+2+1). A value “1000” corresponds to “1” (=+8−4−2−1). A value “1111” corresponds to “15” (=+8+4+2+1).

In the piece of data in the bit-wise binary format, for example, it is possible to use only higher-order 1 bit (the bit b3) of such pieces of data of 4 bits. For example, a value “0” in a piece of data of the higher-order 1 bit corresponds to “−8” and a value “1” in the piece of data of the higher-order 1 bit corresponds to “8”.

In addition, it is possible to use, for example, only higher-order 2 bits (the bits b3 and b2) of the pieces of data of 4 bits in the bit-wise binary format. For example, a value “00” in pieces of data of the higher-order 2 bits corresponds to “−12” (=−8−4). A value “01” in the pieces of data of the higher-order 2 bits corresponds to “4−4” (=−8+4). A value “10” in the pieces of data of the higher-order 2 bits corresponds to “4” (=+8−4). A value “11” in the pieces of data of the higher-order 2 bits corresponds to “12” (=+8+4).

In addition, it is possible to use, for example, only higher-order 3 bits (the bits b3, b2, and b1) of the pieces of data of 4 bits in the bit-wise binary format. For example, a value “000” in pieces of data of the higher-order 3 bits corresponds to “−14” (=−8−4−2). A value “011” in the pieces of data of the higher-order 3 bits corresponds to “−2” (=−8+4+2). A value “100” in the pieces of data of the higher-order 3 bits corresponds to “4” (=+8−4−2). A value “111” in the pieces of data of the higher-order 3 bits corresponds to “14” (=+8+4+2).

As illustrated in FIG. 18, in the piece of data in the bit-wise binary format, the decimal number changes linearly with change in the piece of data (in binary number) in the bit-wise binary format in all of a case of using four bits, a case of using the higher-order 3 bits, a case of using the higher-order 2 bits, and a case of using the higher-order 1 bit.

As described above, the convolution operation section 31 is configured to perform a convolution operation while changing the piece of bit data to be used among all the pieces of bit data from the most significant bit to the least significant bit. The convolution operation section 31 is configured to perform the convolution operation while easily changing the piece of bit data to be used by using this piece of data in the bit-wise binary format. For example, in a case of pieces of data of 8 bits, the convolution operation section 31 uses all the pieces of data of 8 bits, which makes it possible to perform the convolution operation with high accuracy. In addition, for example, the convolution operation section 31 uses pieces of data of higher-order 4 bits among the pieces of data of 8 bits, which makes it possible to reduce power consumption in the imaging device 1. The convolution operation section 31 uses the piece of data in the bit-wise binary format, which makes it possible to change operation accuracy seamlessly without performing a complicated operation.

### Convolution Operation Section 31

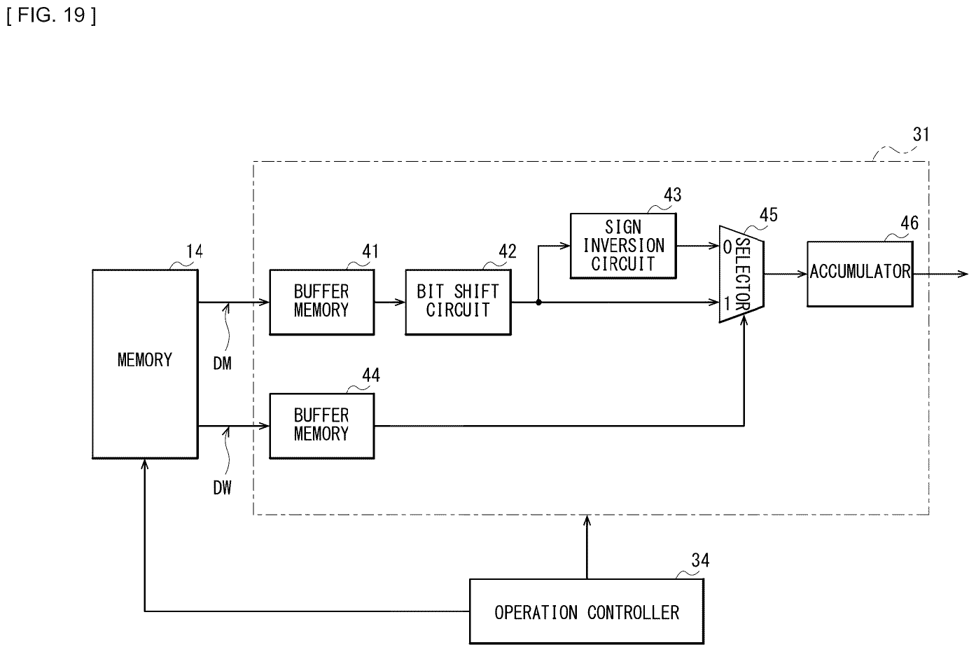

FIG. 19 illustrates a configuration example of the convolution operation section 31. FIG. 19 illustrates a circuit example in a case where the convolution operation section 31 performs a convolution operation using the piece of weighting coefficient data DW in the bit-wise binary format on the piece of data DM represented by two's complement. The convolution operation section 31 includes a buffer memory 41, a bit shift circuit 42, a sign inversion circuit 43, a buffer memory 44, a selector 45, and an accumulator 46.

The buffer memory 41 is configured to temporarily store the piece of data DM supplied from the memory 14. One or a plurality of pieces of word data WORD read from the memory 14 on the basis of a readout address supplied from the operation controller 34 is stored in the buffer memory 41. The bit shift circuit 42 is configured to perform a bit shift on pieces of data from the most significant bit to the least significant bit included in a piece of data supplied from the buffer memory 41. The sign inversion circuit 43 is configured to perform sign inversion on a piece of data supplied from the bit shift circuit 42. The buffer memory 44 is configured to temporarily store the piece of weighting coefficient data DW supplied from the memory 14. One or a plurality of pieces of word data WORD read from the memory 14 on the basis of the readout address supplied from the operation controller 34 is stored in the buffer memory 44. The buffer memory 44 supplies, to the selector 45, pieces of bit data in a piece of data in the bit-wise binary format one by one in order from the most significant bit. The selector 45 is configured to select one of the piece of data supplied from the bit shift circuit 42 and a piece of data supplied from the sign inversion circuit 43 on the basis of the piece of bit data supplied from the buffer memory 44, and output the selected piece of data. Specifically, the selector 45 outputs the piece of data supplied from the bit shift circuit 42 in a case where the piece of data supplied from the buffer memory 44 is “1”, and outputs the piece of data supplied from the sign inversion circuit 43 in a case where the piece of data supplied from the buffer memory 44 is “0”. The accumulator is configured to accumulate a value of the piece of data supplied from the selector 45.

For example, in a case where the convolution operation section 31 performs the point-wise convolution operation CONVP, as illustrated in FIG. 4, the convolution operation section 31 performs a multiplication of the piece of data (a hatched part) in the convolution operation region of the piece of map data M1 by the piece of coefficient data W1A, performs a multiplication of the piece of data (a hatched part) in the convolution operation region of the piece of map data M2 by the piece of coefficient data W2A, performs a multiplication of the piece of data (a hatched part) in the convolution operation region of the piece of map data M3 by the piece of coefficient data W3A, and adds results of these multiplications together, thereby calculating the piece of data (a hatched part) on the far left in the uppermost row in the piece of map data MA.

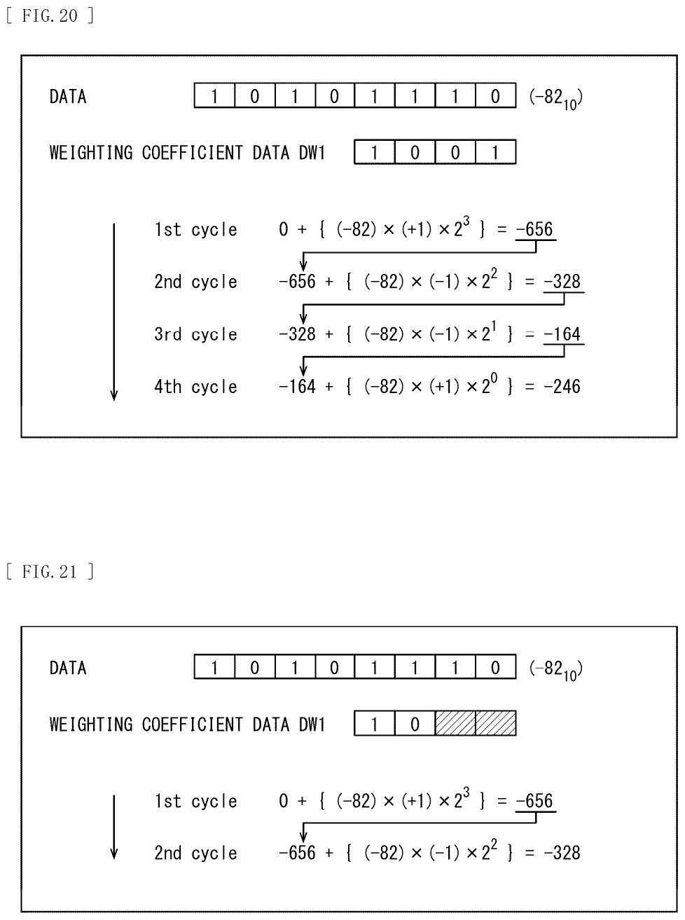

FIG. 20 illustrates an operation in a case of performing a multiplication of the piece of data in the convolution operation region of the piece of map data M1 by the piece of coefficient data W1A. In this example, the piece of data in the convolution operation region of the piece of map data M1 includes pieces of data of 8 bits represented by two's complement, and the piece of coefficient data W1A includes pieces of data of 4 bits in the bit-wise binary format.

First, in a first cycle, the buffer memory 41 supplies pieces of data of 8 bits to the bit shift circuit 42. A value represented by the pieces of data supplied to the bit shift circuit 42 in this example is “−82” in decimal number. In the first cycle, the bit shift circuit 42 shifts the supplied pieces of data by 3 bits to thereby multiply the value by a factor of 8 (=2\hat{ }3). The sign inversion circuit 43 inverts the sign of a value supplied from the bit shift circuit 42. The buffer memory 44 supplies, to the selector 45, a piece of most significant bit data in the piece of coefficient data W1A. In this example, the piece of coefficient data W1A is “1001”, and the piece of most significant bit data is “1”; therefore, the selector 45 outputs the value supplied from the bit shift circuit 42. The accumulator 46 accumulates the value supplied from the selector 45. In this example, the accumulator 46 is immediately after being reset; therefore, the accumulator 46 stores the value supplied from the selector 45 as it is. In this way, the convolution operation section 31 performs the following operation.

$$0 + \{ ( - 82 ) \times ( + 1 ) \times 2 \hat{} 3 \} = - 656$$

In a second cycle, the bit shift circuit 42 shifts the supplied pieces of data by 2 bits to thereby multiply the value by a factor of 4 (=\hat{ }2). The sign inversion circuit 43 inverts the sign of a value supplied from the bit shift circuit 42. The buffer memory 44 supplies, to the selector 45, the second piece of bit data from the most significant bit of the piece of coefficient data W1A. In this example, the second piece of bit data from the most significant bit is “0”; therefore, the selector 45 outputs a value supplied from the sign inversion circuit 43. The accumulator 46 accumulates the value supplied from the selector 45. In this example, the accumulator 46 adds the value supplied from the selector 45 to a value (“−656”) obtained in the first cycle. In this way, the convolution operation section 31 performs the following operation.

$$- 656 + \{ ( - 82 ) \times ( - 1 ) \times 2 \hat{} 2 \} = - 328$$

In a third cycle, the bit shift circuit 42 shifts the supplied pieces of data by 1 bit to thereby multiply the value by a factor of 2 (=2\hat{ }1). The sign inversion circuit 43 inverts the sign of a value supplied from the bit shift circuit 42. The buffer memory 44 supplies, to the selector 45, the third piece of bit data from the most significant bit of the piece of coefficient data W1A. In this example, the third piece of bit data from the most significant bit is “0”; therefore, the selector 45 outputs a value supplied from the sign inversion circuit 43. The accumulator 46 accumulates the value supplied from the selector 45. In this example, the accumulator 46 adds the value supplied from the selector 45 to a value (“−328”) obtained in the second cycle. In this way, the convolution operation section 31 performs the following operation.

$$- 328 + \{ ( - 82 ) \times ( - 1 ) \times 2 \hat{} 1 \} = - 164$$

In a fourth cycle, the bit shift circuit 42 outputs the supplied pieces of data as it is without shifting the supplied pieces of data. The sign inversion circuit 43 inverts the sign of a value supplied from the bit shift circuit 42. The buffer memory 44 supplies, to the selector 45, a piece of least significant bit data in the piece of coefficient data W1A. In this example, the piece of least significant bit data is “1”; therefore, the selector 45 outputs the value supplied from the bit shift circuit 42. The accumulator 46 accumulates the value supplied from the selector 45. In this example, the accumulator 46 adds the value supplied from the selector 45 to a value (“−164”) obtained in the third cycle. In this way, the convolution operation section 31 performs the following operation.

$$- 164 + \{ ( - 82 ) \times ( + 1 ) \times 2 \hat{} 0 \} = - 246$$

Thus, the convolution operation section 31 performs a multiplication of the piece of data (a hatched part) in the convolution operation region of the piece of map data M1 by the piece of coefficient data W1A, following which the convolution operation section 31 performs a multiplication of the piece of data in the convolution operation region of the piece of map data M2 by the piece of coefficient data W2A, and performs a multiplication of the piece of data in the convolution operation region of the piece of map data M3 by the piece of coefficient data W3A. Thus, a value obtained by adding results of these three multiplications together is stored in the accumulator 46. The convolution operation section 31 performs the point-wise convolution operation CONVP in such a manner.

The convolution operation section 31 is configured to perform a convolution operation while changing the piece of bit data to be used among all the pieces of bit data from the most significant bit to the least significant bit.

FIG. 21 illustrates another operation in a case of performing a multiplication of the piece of data (a hatched part) in the convolution operation region of the piece of map data M1 by the piece of coefficient data W1A. In this example, the piece of coefficient data W1A includes pieces of data of higher-order 2 bits (“10”) among the pieces of data of 4 bits (“1001”) in the bit-wise binary format. In this case, the convolution operation section 31 performs only the first cycle and the second cycle with use of the pieces of data of the higher-order 2 bits, which makes it possible to perform the point-wise convolution operation CONVP using the pieces of data of the higher-order 2 bits.

It is to be noted that the description has been given with reference to the point-wise convolution operation CONVP as an example; however, the same applies to the depth-wise convolution operation CONVD.

### Post-Processing Operation Section 32

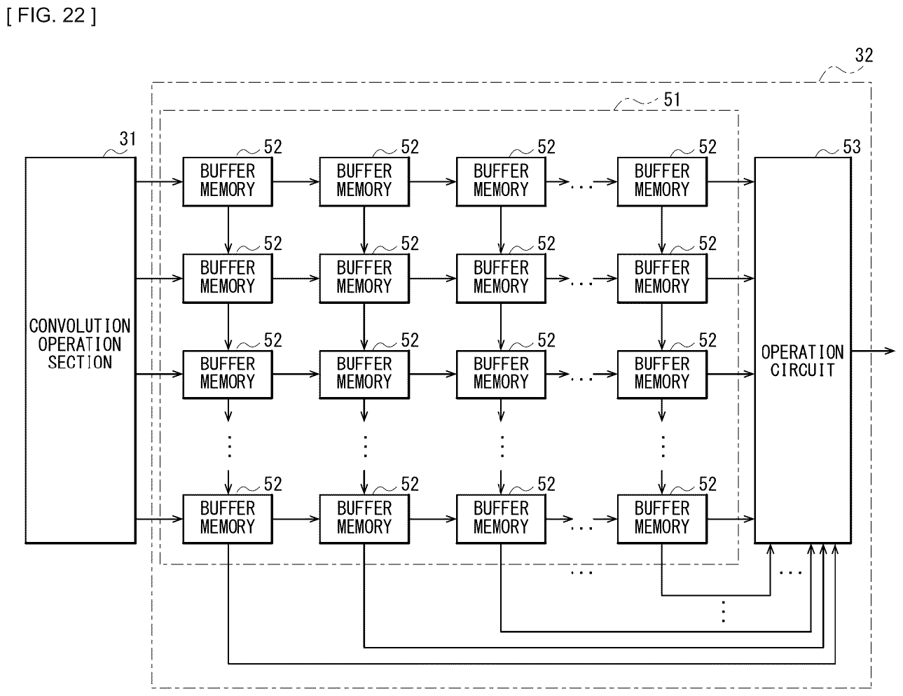

FIG. 22 illustrates a configuration example of the post-processing operation section 32. The post-processing operation section 32 includes a transposition processing circuit 51 and an operation circuit 53.

The transposition processing circuit 51 is configured to perform transposition processing on pieces of data supplied from the convolution operation section 31. The transposition processing circuit 51 includes a plurality of buffer memories 52. The plurality of buffer memories 52 is coupled in a matrix. A plurality of buffer memories 52 coupled to the convolution operation section 31 among the plurality of buffer memories 52 temporarily stores the pieces of data supplied from the convolution operation section 31. Thereafter, the plurality of buffer memories 52 of the transposition processing circuit 51 is configured to sequentially move the stored pieces of data rightward or sequentially move the stored pieces of data downward. For example, in a case where the transposition processing circuit 51 does not perform transposition processing, the plurality of buffer memories 52 of the transposition processing circuit 51 sequentially moves the stored pieces of data rightward to thereby supply all the pieces of data to the operation circuit 53 subsequent to the transposition processing circuit 51. In addition, in a case where the transposition processing circuit 51 performs transposition processing, the plurality of buffer memories 52 of the transposition processing circuit 51 sequentially moves the stored pieces of data downward to thereby supply all the pieces of data to the operation circuit 53 subsequent to the transposition processing circuit 51.

The operation circuit 53 is configured to perform a predetermined operation including a quantization operation and the like on the basis of the pieces of data supplied from the transposition processing circuit 51. Thereafter, the operation circuit 53 stores a result of the operation in the memory 14.

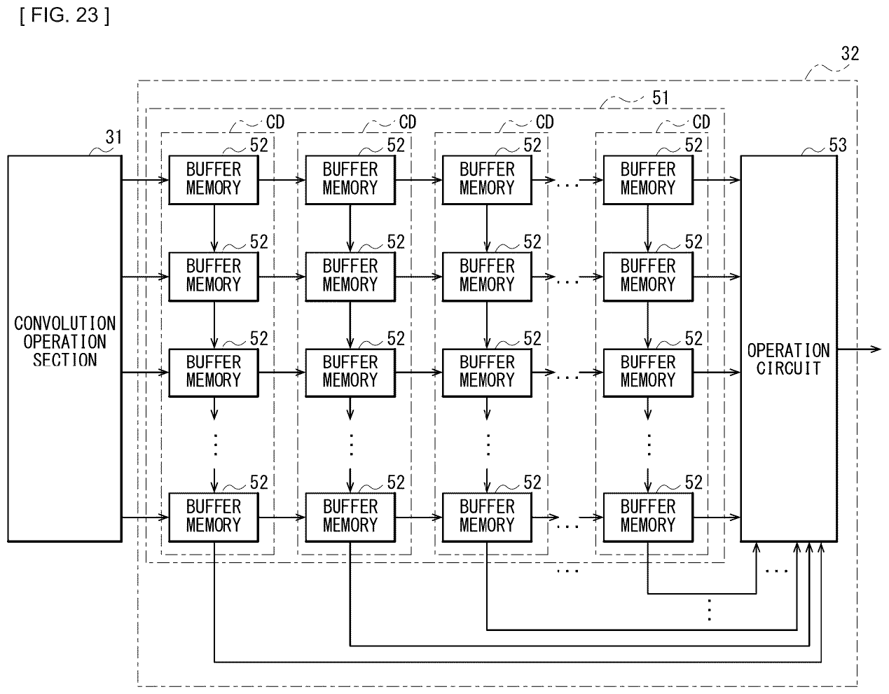

FIG. 23 illustrates an operation example of the transposition processing circuit 51. For example, in a case where the convolution operation section 31 performs the point-wise convolution operation CONVP, as illustrated in FIG. 4, for example, the convolution operation section 31 performs a convolution operation using the piece of coefficient data W1A on the piece of map data M1, performs a convolution operation using the piece of coefficient data W2A on the piece of map data M2, and performs a convolution operation using the piece of coefficient data W3A on the piece of map data M3, thereby generating the piece of map data MA. The piece of map data MA is a piece of channel data CD corresponding to one channel. The convolution operation section 31 repeats this operation to thereby generate a plurality of pieces of map data. In this way, the convolution operation section 31 generates a plurality of pieces of channel data CD corresponding to a plurality of channels. Each of the plurality of pieces of channel data CD is stored in the buffer memories 52 for one column provided side by side in the longitudinal direction, as illustrated in FIG. 23.

For example, in a case where the convolution operation section 31 next performs the point-wise convolution operation CONVP again, the transposition processing circuit 51 does not perform transposition processing. In this case, the plurality of buffer memories 52 of the transposition processing circuit 51 sequentially moves the stored pieces of data rightward to thereby supply all the pieces of data to the operation circuit 53 subsequent to the transposition processing circuit 51.

For example, in a case where the convolution operation section 31 next performs the depth-wise convolution operation CONVD, the transposition processing circuit 51 performs transposition processing. In this case, the plurality of buffer memories 52 of the transposition processing circuit 51 sequentially moves the stored pieces of data downward to thereby supply all the pieces of data to the operation circuit 53 subsequent to the transposition processing circuit 51.

It is to be noted that, in this example, a case where the convolution operation section 31 performs the point-wise convolution operation CONVP has been described as an example; however, the same applies to a case where the convolution operation section 31 performs the depth-wise convolution operation CONVD. The transposition processing circuit 51 does not perform transposition processing in a case where the convolution operation section 31 performs the depth-wise convolution operation CONVD immediately before and then performs the depth-wise convolution operation CONVD again. In addition, the transposition processing circuit 51 performs transposition processing in a case where the convolution operation section 31 performs the depth-wise convolution operation CONVD immediately before and then performs the point-wise convolution operation CONVP.

Thus, the transposition processing circuit 51 performs transposition processing when the convolution operation of the convolution operation section 31 changes from the point-wise convolution operation CONVP to the depth-wise convolution operation CONVD and when the convolution operation of the convolution operation section 31 changes from the depth-wise convolution operation CONVD to the point-wise convolution operation CONVP.

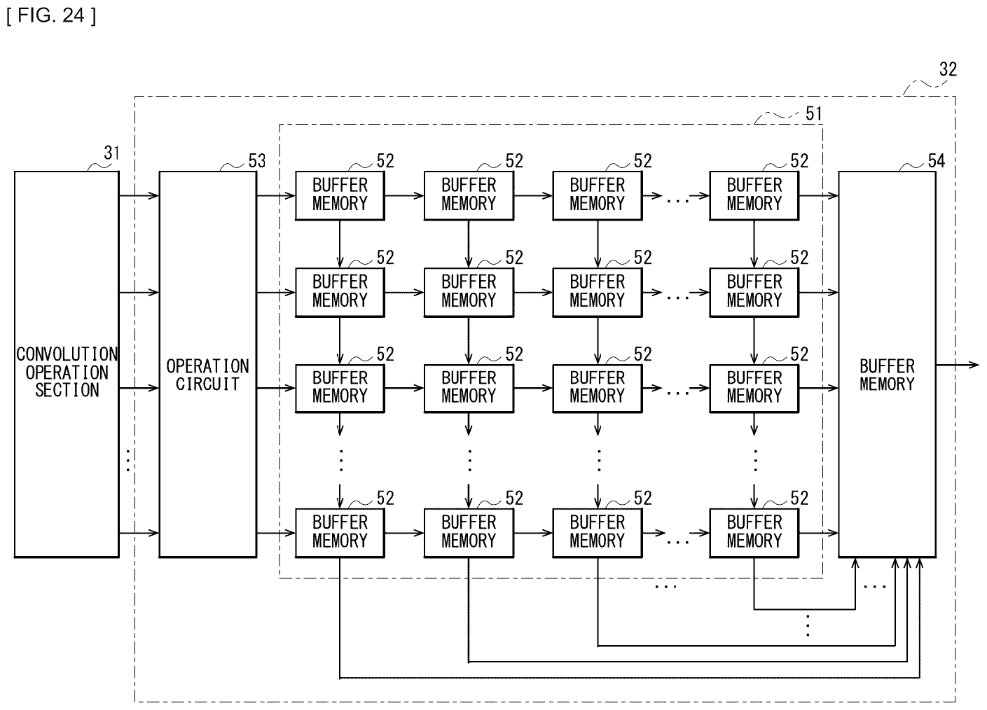

FIG. 24 illustrates another configuration example of the post-processing operation section 32. The post-processing operation section 32 includes the operation circuit 53, the transposition processing circuit 51, and a buffer memory 54.

The operation circuit 53 is configured to perform a predetermined operation including a quantization operation and the like on the basis of the pieces of data supplied from the convolution operation section 31.

The transposition processing circuit 51 is configured to perform transposition processing on pieces of data supplied from the operation circuit 53. In a case where the transposition processing circuit 51 does not perform transposition processing, the plurality of buffer memories 52 of the transposition processing circuit 51 sequentially moves the stored pieces of data rightward to thereby supply all the pieces of data to the buffer memory 54 subsequent to the transposition processing circuit 51. In addition, in a case where the transposition processing circuit 51 performs transposition processing, the plurality of buffer memories 52 of the transposition processing circuit 51 sequentially moves the stored pieces of data downward to thereby supply all the pieces of data to the buffer memory 54 subsequent to the transposition processing circuit 51.

The buffer memory 54 is configured to temporarily store the pieces of data supplied from the transposition processing circuit 51. Thereafter, the buffer memory 54 supplies the stored pieces of data to the memory 14 to store the pieces of data in the memory 14.

### About Writing Model Parameter to Imaging Device 1

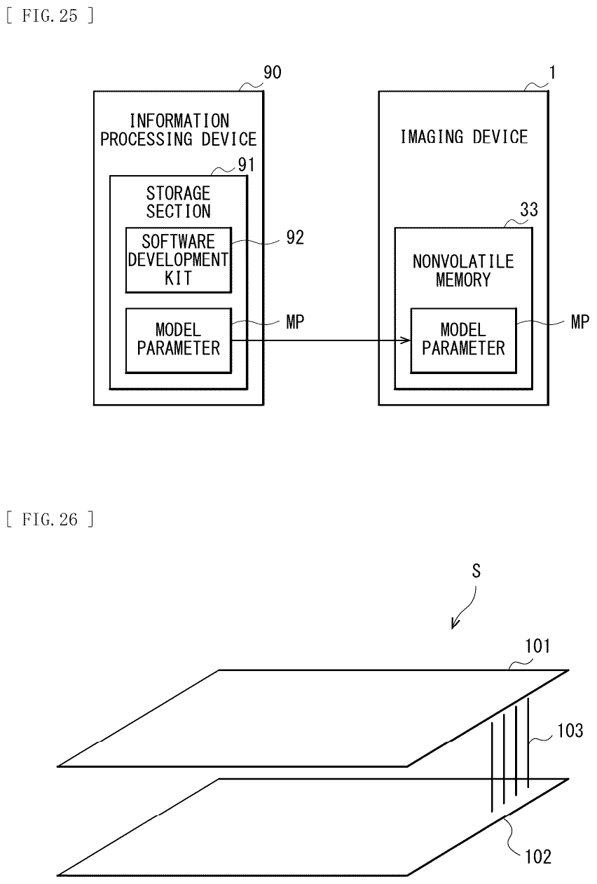

FIG. 25 illustrates an example of writing of a model parameter to the imaging device 1. The model parameter is generated by, for example, an information processing device 90. The information processing device 90 is, for example, a personal computer. A software development kit (SDK) 92 is installed in a storage section 91 of the information processing device 90. The storage section 91 includes, for example, an HDD (Hard Disk Drive) or an SSD (Solid State Drive).

The information processing device 90 executes the software development kit 92 to perform machine learning processing, thereby generating a model parameter MP of the neural network. The model parameter MP is stored in the storage section 91. The model parameter MP includes a plurality of pieces of weighting coefficient data DW (pieces of weighting coefficient data DW1, DW2, DW3, . . . ) illustrated in FIG. 3, for example. The pieces of weighting coefficient data DW are stored in the storage section 91 in a data arrangement as illustrated in FIGS. 12, 14, 15, or 16. That is, pieces of bit data related to a plurality of most significant bits are provided side by side in a certain piece of word data WORD in the storage section 91.

Thereafter, the information processing device 90 writes the model parameter MP as a piece of data to the nonvolatile memory 33 of the imaging device 1. Specifically, the information processing device 90 writes this model parameter MP to the nonvolatile memory 33 with use of a write control command generated by the software development kit 92. This allows the recognition processor 30 of the imaging device 1 to perform recognition processing with use of the model parameter MP.

### About Implementation of Imaging Device 1

The imaging device 1 may be formed on one semiconductor substrate, or may be formed on a plurality of semiconductor substrates. An example in which the imaging device 1 is formed on two semiconductor substrates is described in detail below.

FIG. 26 illustrates an implementation example of the imaging device 1. In this example, the imaging device 1 is formed on two semiconductor substrates 101 and 102. The semiconductor substrate 101 is provided on side of an imaging surface S of the imaging device 1, and the semiconductor substrate 102 is provided on side opposite to the imaging surface S of the imaging device 1. The semiconductor substrates 101 and 102 are superimposed on each other. A wiring of the semiconductor substrate 101 and a wiring of the semiconductor substrate 102 are coupled to each other by a coupling section 103. It is possible to use, for example, a through silicon via (TSV: Through Silicon Via), Cu—Cu bonding, a microbump, or the like for the coupling section 103. The imaging device 1 is provided over these two semiconductor substrates 101 and 102.

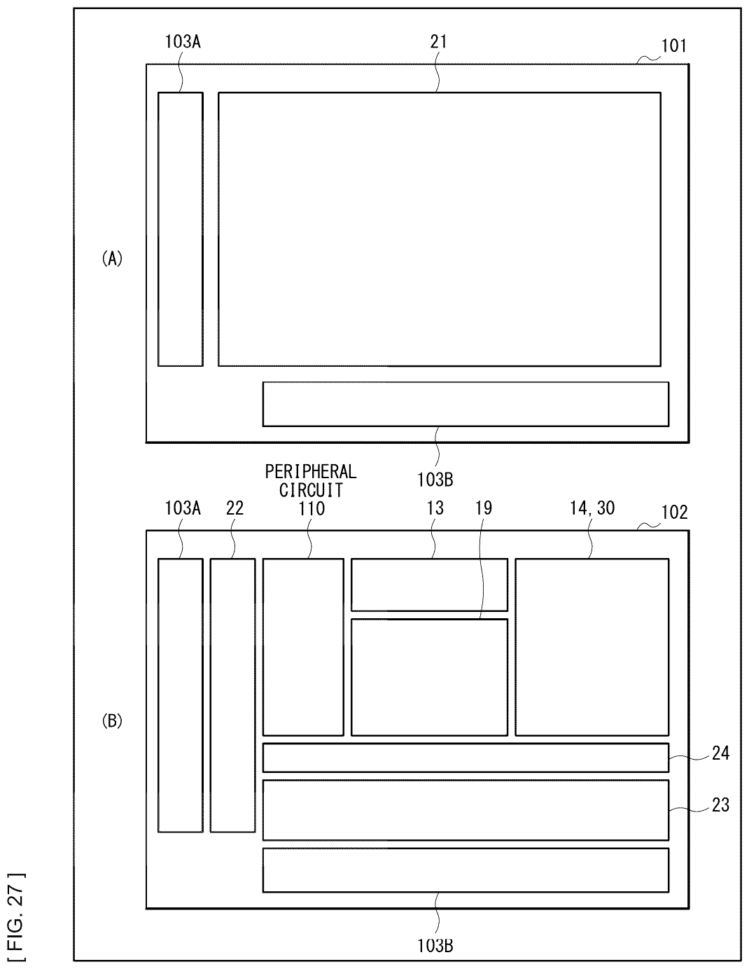

FIG. 27 illustrates a layout example of respective circuits of the imaging device 1 on the semiconductor substrates 101 and 102. The pixel array 21 is provided on the semiconductor substrate 101. The coupling section 103 (coupling sections 103A and 103B) is provided in regions corresponding to each other on the semiconductor substrates 101 and 102. Specifically, the coupling section 103A is provided around left sides of the semiconductor substrates 101 and 102, and the coupling section 103B is provided around lower sides of the semiconductor substrates 101 and 102. A driving section 22 is provided on the right of the coupling section 103A on the semiconductor substrate 102. Accordingly, the driving section 22 generates a control signal, and supplies the control signal to the plurality of light-receiving pixels P of the pixel array 21 via the coupling section 103A on the semiconductor substrates 101 and 102. The AD converter 23 is provided above the coupling section 103B. Accordingly, a pixel signal supplied from the pixel array 21 is supplied to the AD converter 23 via the coupling section 103B on the semiconductor substrates 101 and 102. The horizontal scanner 24 is provided above the AD converter 23. The sensor controller 19 is provided around a middle of the semiconductor substrate 102, and the signal processor 13 is provided above the sensor controller 19. The memory 14 and the recognition processor 30 are provided on the right of the sensor controller 19. The peripheral circuit 110 is another circuit, and is provided on the left of the sensor controller 19 and the signal processor 13. The peripheral circuit 110 includes, for example, a phase locked loop (PLL: Phase Locked Loop), a LDO (Low Drop Out) regulator, a charge pump, or the like.

Here, the memory 14 corresponds to a specific example of a “storage section” in an embodiment of the present disclosure. The convolution operation section 31 corresponds to a specific example of a “convolution operation section” in an embodiment of the present disclosure. The piece of data DM corresponds to a specific example of a “piece of processing target data” in an embodiment of the present disclosure. The piece of map data M corresponds to a specific example of a “piece of map data” in an embodiment of the present disclosure. The piece of weighting coefficient data DW corresponds to a specific example of a “piece of weighting coefficient data” in an embodiment of the present disclosure. The post-processing operation section 32 corresponds to a specific example of a “post-processing operation section” in an embodiment of the present disclosure. The plurality of buffer memories 52 corresponds to a specific example of a “plurality of buffer memories” in an embodiment of the present disclosure. The imaging section 11 corresponds to a specific example of a “photodetecting section” in an embodiment of the present disclosure.

### Operation and Workings

Next, description is given of operation and workings of the imaging device 1 according to the present embodiment.

### Overview of Overall Operation

First, description is given of an overview of an overall operation of the imaging device 1 with reference to FIG. 1. The imaging section 11 performs an imaging operation of imaging a subject, and outputs a result of the imaging as the piece of image data Dpic. The buffer memory 12 temporarily stores the piece of image data Dpic supplied from the imaging section 11. The signal processor 13 performs various types of image processing such as noise removal processing or black level adjustment processing on the piece of image data Dpic supplied from the buffer memory 12 to thereby generate the piece of image data Dpic1. The memory 14 stores, for example, the piece of image data Dpic1 supplied from the signal processor 13. In addition, the memory 14 stores the piece of image data DM and the piece of weighting coefficient data DW that are to be used when the recognition processor 30 performs recognition processing. The recognition processor 30 performs recognition processing using the neural network on the basis of pieces of data stored in the memory 14. The communication section 15 transmits, to the processor 100, a piece of image data and a piece of data representing a processing result of the recognition processing that are supplied from the memory 14. The sensor controller 19 controls operations of the buffer memory 12, the signal processor 13, the memory 14, and the communication section 15.

### Detailed Operation

In the recognition processor 30, the convolution operation section 31 performs the convolution operation CONV using the neural network on the basis of an instruction from the operation controller 34. The post-processing operation section 32 performs the predetermined post-processing operation POST including a quantization operation, transposition processing, and the like on a result of the operation by the convolution operation section 31 on the basis of an instruction from the operation controller 34. The nonvolatile memory 33 stores the model parameter of the neural network to be used in recognition processing in the recognition processor 30. The operation controller 34 controls operations of the convolution operation section 31 and the post-processing operation section 32 on the basis of the model parameter supplied from the nonvolatile memory 33 to thereby control recognition processing in the recognition processor 30.

The convolution operation section 31 performs the convolution operation CONV while changing the piece of bit data to be used among all the pieces of bit data from the most significant bit to the least significant bit.

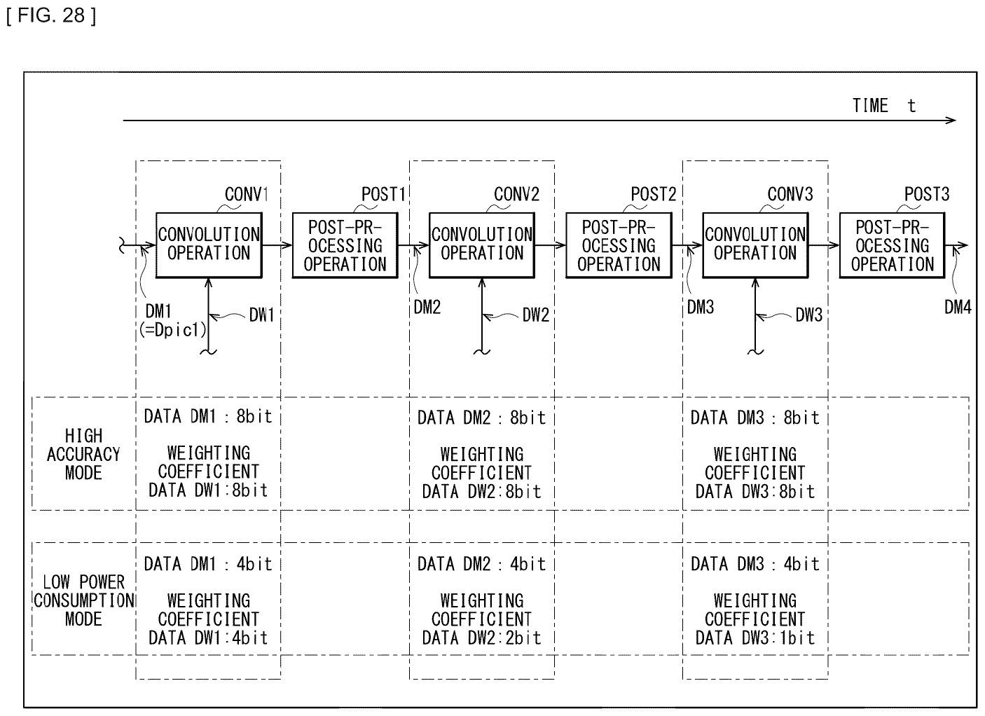

FIG. 28 illustrates an operation example of the recognition processor 30. In this example, for description convenience, the convolution operation section 31 performs three convolution operations CONV1, CONV2, and CONV3, and ends processing. The pieces of weighting coefficient data DW1, DW2, and DW3 supplied from the operation controller 34 are stored in the memory 14. These pieces of weighting coefficient data DW1, DW2, and DW3 stored in the memory 14 each include pieces of data of 8 bits. In addition, pieces of data DM1 to DM3 stored in the memory 14 each include pieces of data of 8 bits.

In this example, the recognition processor 30 has a high accuracy mode and a low power consumption mode. The high accuracy mode is an operation mode in which accuracy of recognition processing is high. The recognition processor 30 operates in this high accuracy mode in a case where, upon performing face recognition on the basis of a captured image, for example, a face image is small because a subject is far from the imaging device 1 or the face image is dark due to shadows. The low power consumption mode is an operation mode in which accuracy of recognition processing is slightly low and makes it possible to reduce power consumption. The recognition processor 30 operates in this low power consumption mode in a case where, upon performing face recognition on the basis of a captured image, for example, a face image is large and clear and a face is recognizable sufficiently even with low accuracy of recognition processing.

First, description is given of an operation of the recognition processor 30 in the high accuracy mode.

The piece of image data Dpic1 supplied from the signal processor 13 is stored in the memory 14. The piece of image data Dpic1 includes pieces of data of 8 bits. In the first convolution operation CONV1, the piece of image data Dpic1 is used as the piece of data DM1. The memory 14 reads the piece of image data Dpic1 including pieces of data of 8 bits on the basis of a readout address supplied from the operation controller 34, and supplies the read piece of data as the piece of data DM1 to the convolution operation section 31. In addition, the memory 14 reads the piece of weighting coefficient data DW1 including pieces of data of 8 bits on the basis of a readout address supplied from the operation controller 34, and supplies the piece of weighting coefficient data DW1 to the convolution operation section 31.

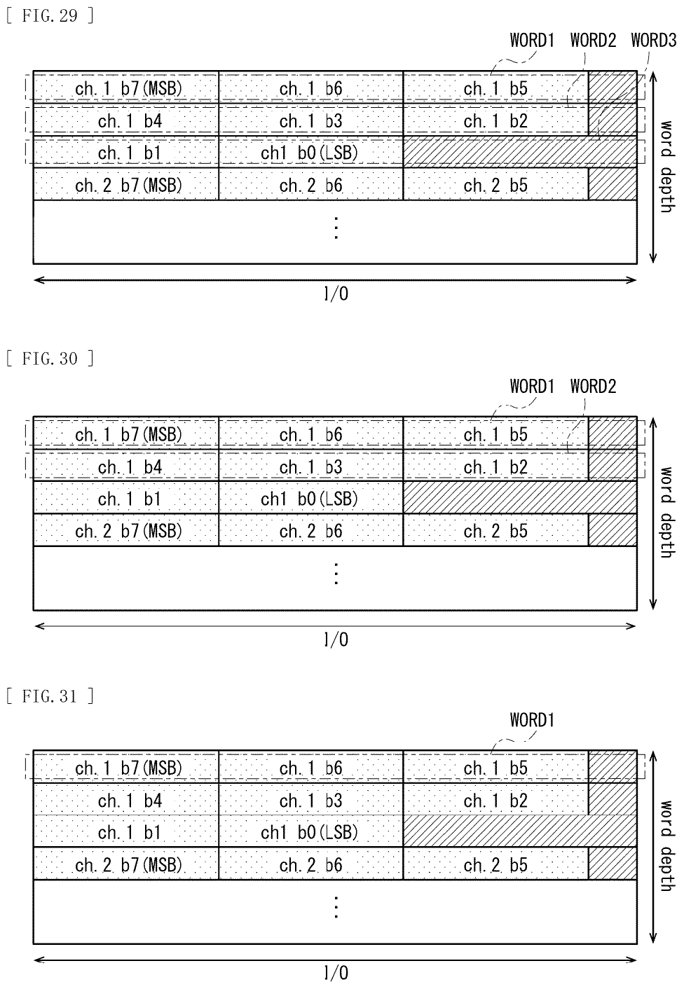

FIG. 29 illustrates an example of the piece of weighting coefficient data DW1 to be read from the memory 14. In this example, the pieces of weighting coefficient data DW1, DW2, and DW3 are arranged in the data arrangement illustrated in FIG. 15 in the memory 14. In this example, the memory 14 reads three pieces of word data WORD (the pieces of word data WORD1, WORD2, and WORD3) on the basis of a readout address supplied from the operation controller 34 to thereby read pieces of data for 8 bits related to the first channel (ch.1) in the piece of weighting coefficient data DW1. The same applies to other channels. In addition, this example has been described with reference to the piece of weighting coefficient data DW1 as an example, but the same applies to the piece of data DM1.

Thereafter, the convolution operation section 31 performs the convolution operation CONV1 on the basis of the piece of data DM1 and the piece of weighting coefficient data DW1. The post-processing operation section 32 performs the post-processing operation POST1 on a result of the operation by the convolution operation section 31, and writes a result of the operation as the piece of data DM2 to the memory 14 on the basis of a write address supplied from the operation controller 34.

Next, the memory 14 reads the piece of data DM2 including pieces of data of 8 bits on the basis of a readout address supplied from the operation controller 34, and supplies the piece of data DM2 to the convolution operation section 31. In addition, the memory 14 reads the piece of weighting coefficient data DW2 including pieces of data of 8 bits on the basis of a readout address supplied from the operation controller 34, and supplies the piece of weighting coefficient data DW2 to the convolution operation section 31. The convolution operation section 31 performs the convolution operation CONV2 on the basis of the piece of data DM2 and the piece of weighting coefficient data DW2. The post-processing operation section 32 performs the post-processing operation POST2 on a result of the operation by the convolution operation section 31, and supplies a result of the operation as the piece of data DM3 to the memory 14 on the basis of a write address supplied from the operation controller 34.

Next, the memory 14 reads the piece of data DM3 including pieces of data of 8 bits on the basis of a readout address supplied from the operation controller 34, and supplies the piece of data DM3 to the convolution operation section 31. In addition, the memory 14 reads the piece of weighting coefficient data DW3 including pieces of data of 8 bits on the basis of a readout address supplied from the operation controller 34, and supplies the piece of weighting coefficient data DW3 to the convolution operation section 31. The convolution operation section 31 performs the convolution operation CONV3 on the basis of the piece of data DM3 and the piece of weighting coefficient data DW3. The post-processing operation section 32 performs the post-processing operation POST3 on a result of the operation by the convolution operation section 31, and supplies a result of the operation as the piece of data DM4 to the memory 14 on the basis of a write address supplied from the operation controller 34.

Thus, in the high accuracy mode, the recognition processor 30 performs the convolution operations CONV1 to CONV3 using the pieces of data of 8 bits in the piece of data DM and the pieces of data of 8 bits in the piece of weighting coefficient data DW of 8 bits in this example. This allows the recognition processor 30 to perform recognition processing with high accuracy.

Next, description is given of an operation of the recognition processor 30 in the low power consumption mode.

First, the piece of image data Dpic1 supplied from the signal processor 13 is stored in the memory 14. The piece of image data Dpic1 includes pieces of data of 8 bits. In the first convolution operation CONV1, the piece of image data Dpic1 is used as the piece of data DM1. The memory 14 reads pieces of data of higher-order 4 bits in the piece of image data Dpic1 including the pieces of data of 8 bits on the basis of a readout address supplied from the operation controller 34, and supplies the read pieces of data as the piece of data DM1 to the convolution operation section 31. In addition, the memory 14 reads pieces of data of higher-order 4 bits in the piece of weighting coefficient data DW1 including the pieces of data of 8 bits on the basis of a readout address supplied from the operation controller 34, and supplies the read pieces of weighting coefficient data DW1 to the convolution operation section 31.

FIG. 30 illustrates an example of the piece of weighting coefficient data DW1 read from the memory 14. In this example, the memory 14 reads two pieces of word data (the pieces of word data WORD1 and WORD2) including the bit b7 (“ch.1 b7(MSB)”), the bit b6 (“ch.1 b6”), the bit b5 (“ch.1 b5”), and the bit b4 (“ch.1 b4”) on the basis of a readout address supplied from the operation controller 34 to thereby read pieces of data for higher-order 4 bits related to the first channel (ch.1) in the piece of weighting coefficient data DW1. The same applies to other channels. This example has been described with reference to the piece of weighting coefficient data DW1 as an example, but the same applies to the piece of data DM1.

Thereafter, the convolution operation section 31 performs the convolution operation CONV1 on the basis of the piece of data DM1 and the piece of weighting coefficient data DW1. That is, the piece of data DM1 used in the convolution operation CONV1 includes pieces of data of higher-order 4 bits among the pieces of data of 8 bits, and the piece of weighting coefficient data DW1 used in the convolution operation CONV1 includes pieces of data of higher-order 4 bits among the pieces of data of 8 bits. The post-processing operation section 32 performs the post-processing operation POST1 on a result of the operation by the convolution operation section 31. The post-processing operation section 32 performs a quantization operation so as to generate pieces of data of 8 bits. Thereafter, the post-processing operation section 32 writes a result of the operation as the piece of data DM2 to the memory 14 on the basis of a write address supplied from the operation controller 34.

Next, the memory 14 reads pieces of data of higher-order 4 bits in the piece of data DM2 including pieces of data of 8 bits on the basis of a readout address supplied from the operation controller 34, and supplies the read pieces of data in the piece of data DM2 to the convolution operation section 31. In addition, the memory 14 reads pieces of data of higher-order 2 bits in the piece of weighting coefficient data DW2 including the pieces of data of 8 bits on the basis of a readout address supplied from the operation controller 34, and supplies the read pieces of data in the piece of the weighting coefficient data DW2 to the convolution operation section 31.

FIG. 31 illustrates an example of the piece of weighting coefficient data DW2 read from the memory 14. In this example, the memory 14 reads one piece of word data WORD (the piece of word data WORD1) including the bit b7 (“ch.1 b7(MSB)”) and the bit b6 (“ch.1 b6”) on the basis of a readout address supplied from the operation controller 34 to thereby read pieces of data for higher-order 2 bits related to the first channel (ch.1) in the piece of weighting coefficient data DW2. The same applies to other channels.

Thereafter, the convolution operation section 31 performs the convolution operation CONV2 on the basis of the piece of data DM2 and the piece of weighting coefficient data DW2. That is, the piece of data DM2 used in the convolution operation CONV2 includes pieces of data of higher-order 4 bits among the pieces of data of 8 bits, and the piece of weighting coefficient data DW2 used in the convolution operation CONV2 includes pieces of data of higher-order 2 bits among the pieces of data of 8 bits. The post-processing operation section 32 performs the post-processing operation POST2 on a result of the operation by the convolution operation section 31. The post-processing operation section 32 performs a quantization operation so as to generate pieces of data of 8 bits. Thereafter, the post-processing operation section 32 writes a result of the operation as the piece of data DM3 to the memory 14 on the basis of a write address supplied from the operation controller 34.

Next, the memory 14 reads pieces of data of higher-order 4 bits in the piece of data DM3 including pieces of data of 8 bits on the basis of a readout address supplied from the operation controller 34, and supplies the read pieces of data of the piece of data DM3 to the convolution operation section 31. In addition, the memory 14 reads a piece of data of higher-order 1 bit of the piece of weighting coefficient data DW3 including pieces of data of 8 bits on the basis of a readout address supplied from the operation controller 34, and supplies the read piece of data of the pieces of weighting coefficient data DW3 to the convolution operation section 31. Specifically, as illustrated in FIG. 31, the memory 14 reads one piece of word data WORD (the piece of word data WORD1) on the basis of a readout address supplied from the operation controller 34 to thereby read a piece of data for higher-order 1 bit related to the first channel (ch.1) in the piece of weighting coefficient data DW3. The same applies to other channels. Thereafter, the convolution operation section 31 performs the convolution operation CONV3 on the basis of the piece of data DM3 and the piece of weighting coefficient data DW3. That is, the piece of data DM3 used in the convolution operation CONV3 includes pieces of data of higher-order 4 bits among the pieces of data of 8 bits, and the piece of weighting coefficient data DW3 used in the convolution operation CONV3 includes a piece of data of higher-order 1 bit used among the pieces of data of 8 bits. The post-processing operation section 32 performs the post-processing operation POST3 on a result of the operation by the convolution operation section 31. The post-processing operation section 32 performs a quantization operation so as to generate pieces of data of 8 bits. Thereafter, the post-processing operation section 32 writes a result of the operation as the piece of data DM4 to the memory 14 on the basis of a write address supplied from the operation controller 34.

Thus, in the low power consumption mode, in this example, the recognition processor 30 performs the convolution operation CONV1 using pieces of data of 4 bits in the piece of data DM1 and pieces of data of 4 bits in the piece of weighting coefficient data DW1, performs the convolution operation CONV2 using pieces of data of 4 bits in the piece of data DM2 and pieces of data of 2 bits in the piece of weighting coefficient data DW2, and performs the convolution operation CONV3 using pieces of data of 4 bits in the piece of data DM3 and a pieces of data of 1 bit in the piece of weighting coefficient data DW3. This allows the recognition processor 30 to reduce the number of times of memory access, which makes it possible to reduce power consumption while maintaining recognition accuracy to some extent.

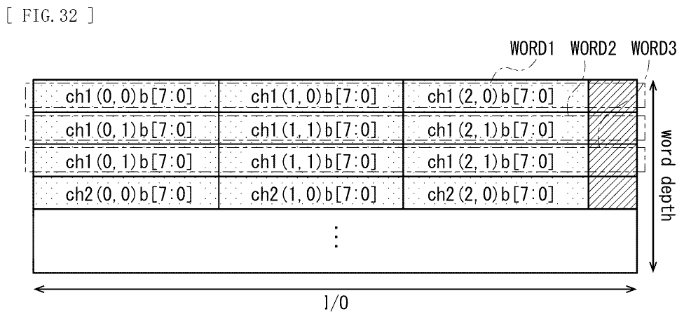

That is, for example, a method may be adopted of arranging the piece of weighting coefficient data DW1 including nine (=3×3) pieces of coefficient data (FIG. 13) in a data arrangement as illustrated in FIG. 32. In this example, in the uppermost piece of word data WORD1, pieces of bit data are arranged in order, from the left, of 8 bits from the most significant bit to the least significant bit at (0, 0), 8 bits from the most significant bit to the least significant bit at (1, 0), and 8 bits from the most significant bit to the least significant bit at (2, 0) of the piece of coefficient data W1A corresponding to the first channel (ch.1). In the second piece of word data WORD2 from the top, pieces of bit data are arranged in order, from the left, of 8 bits from the most significant bit to the least significant bit at (0, 1), 8 bits from the most significant bit to the least significant bit at (1, 1), and 8 bits from the most significant bit to the least significant bit at (2, 1). In the third piece of word data WORD3 from the top, pieces of bit data are arranged in order, from the left, of 8 bits from the most significant bit to the least significant bit at (0, 1), 8 bits from the most significant bit to the least significant bit at (1, 1), and 8 bits from the most significant bit to the least significant bit at (2, 1). In this case, the recognition processor has to read three pieces of word data WORD1 to WORD3 from the memory 14 even in a case where a convolution operation is performed using pieces of data of 8 bits from the most significant bit to the least significant bit and in a case where a convolution operation is performed using a part of the pieces of data of 8 bits.

In contrast, the recognition processor 30 according to the present embodiment reads three pieces of word data WORD1 to WORD3 in a case where a convolution operation is performed using pieces of data of 8 bits from the most significant bit to the least significant bit (FIG. 29), reads two pieces of word data WORD1 and WORD2, for example, in a case where a convolution operation is performed using pieces of data of higher-order 2 bits among the pieces of data of 8 bits (FIG. 30), and reads one piece of word data WORD1 in a case where a convolution operation is performed using a piece of data of higher-order 1 bit among the pieces of data of 8 bits (FIG. 31). This makes it possible to reduce the number of times of memory access, which makes it possible to reduce power consumption while maintaining recognition accuracy to some extent.

Thus, the imaging device 1 includes the memory 14, the convolution operation section 31, and the post-processing operation section 32. The memory 14 is configured to store a plurality of pieces of word data WORD each including at least one of a piece of processing target data (the piece of data DM) or the piece of weighting coefficient data DW and is configured to be accessed in word data WORD units. The convolution operation section 31 is configured to perform the convolution operation CONV on the basis of the piece of processing target data (the piece of data DM) and the piece of weighting coefficient data DW. The post-processing operation section 32 is configured to perform a predetermined operation on the basis of an operation result of the convolution operation CONV and store an operation result as the piece of processing target data (the piece of data DM) in the memory 14. The piece of weighting coefficient data DW includes a plurality of pieces of coefficient data each including a plurality of pieces of bit data. The plurality of pieces of word data include a piece of first word data including two or more pieces of most significant bit data provided side by side, the two or more pieces of most significant bit data being in two or more pieces of coefficient data among the plurality of pieces of coefficient data. Accordingly, in the imaging device 1, two pieces of word data WORD1 and WORD2 are read, for example, in a case where a convolution operation is performed using pieces of data of higher-order 2 bits among the pieces of data of 8 bits (FIG. 30), and one piece of word data WORD1 is read, for example, in a case where a convolution operation is performed using a piece of data of higher-order 1 bit among the pieces of data of 8 bits (FIG. 31). Accordingly, in the imaging device 1, it is possible to reduce the number of times of memory access, which makes it possible to reduce power consumption while maintaining recognition accuracy to some extent.

In addition, in the imaging device 1, for example, as illustrated in FIGS. 4, 11, and 12, the piece of processing target data (the piece of data DM) includes a plurality of pieces of map data M, and each of the plurality of pieces of coefficient data in the piece of weighting coefficient data DW corresponds to the plurality of respective pieces of map data M, and a piece of first word data WORD includes two or more pieces of most significant bit data provided side by side, the two or more pieces of most significant bit data being in two or more pieces of coefficient data among the plurality of pieces of coefficient data corresponding to the plurality of respective pieces of map data M. Accordingly, in the imaging device 1, it is possible to reduce the number of times of memory access when the recognition processor 30 performs the point-wise convolution operation CONVP, which makes it possible to reduce power consumption while maintaining recognition accuracy to some extent.

In addition, in the imaging device 1, for example, as illustrated in FIGS. 5, 13, and 14, the piece of processing target data (piece of data DM) includes a single piece of map data M, and the plurality of piece of coefficient data in the piece of weighting coefficient data DW corresponds to the single piece of map data M. The piece of first word data WORD includes two or more pieces of most significant bit data provided side by side, the two pr more pieces of most significant bit data being in two or more pieces of coefficient data among the plurality of pieces of coefficient data corresponding to the single piece of map data M. Accordingly, in the imaging device 1, it is possible to reduce the number of times of memory access when the recognition processor 30 performs the depth-wise convolution operation CONVD, which makes it possible to reduce power consumption while maintaining recognition accuracy to some extent.

In addition, in the imaging device 1, for example, as illustrated in FIGS. 20 and 21, it is possible for the convolution operation section 31 to sequentially perform the convolution operation in bit data units from a piece of most significant bit data to a piece of least significant bit data on the basis of the plurality of pieces of coefficient data included in the piece of weighting coefficient data DW. Accordingly, in the imaging device 1, it is possible for the recognition processor 30 to perform a convolution operation while changing the piece of bit data to be used among all the pieces of bit data from the most significant bit to the least significant bit. As a result, in the imaging device 1, for example, reducing pieces of bit data to be used makes it possible to reduce the number of times of memory access, which makes it possible to reduce power consumption.

In addition, in the imaging device 1, the piece of processing target data (the piece of data DM) includes a plurality of pieces of data each including a plurality of pieces of bit data, and the plurality of pieces of word data WORD includes a piece of second word data WORD including two or more pieces of most significant bit data provided side by side, the two or more pieces of most significant bit data being in two or more pieces of data among the plurality of pieces of data. Accordingly, in the imaging device 1, it is possible to reduce the number of times of memory access, which makes it possible to reduce power consumption while maintaining recognition accuracy to some extent.

### Effects

As described above, in the present embodiment, a memory, a convolution operation section, and a post-processing operation section are included. The memory is configured to store a plurality of pieces of word data each including at least one of a piece of processing target data or a piece of weighting coefficient data and is configured to be accessed in word data units. The convolution operation section is configured to perform a convolution operation on the basis of the piece of processing target data and the piece of weighting coefficient data. The post-processing operation section is configured to perform a predetermined operation on the basis of an operation result of the convolution operation and store the operation result as the piece of processing target data in the memory. The piece of weighting coefficient data includes a plurality of pieces of coefficient data each including a plurality of pieces of bit data. The plurality of pieces of word data includes a piece of first word data including two or more pieces of most significant bit data provided side by side, the two or more pieces of most significant bit data being in two or more pieces of coefficient data among the plurality of pieces of coefficient data. Accordingly, it is possible to reduce the number of times of memory access, which makes it possible to reduce power consumption.

In the present embodiment, the piece of processing target data includes a plurality of pieces of map data, and the plurality of pieces of coefficient data in the piece of weighting coefficient data corresponds to the plurality of respective pieces of map data, and the piece of first word data includes two or more pieces of most significant bit data provided side by side, the two or more pieces of most significant bit data being in two or more pieces of coefficient data among the plurality of pieces of coefficient data corresponding to the plurality of respective pieces of map data M. This makes it possible to reduce power consumption.

In the present embodiment, the piece of processing target data includes a single piece of map data, and the plurality of pieces of coefficient data in the piece of weighting coefficient data corresponds to the single piece of map data, The piece of first word data includes two or more pieces of most significant bit data provided side by side, the two or more pieces of most significant bit data being in two or more pieces of coefficient data among the plurality of pieces of coefficient data corresponding to the single piece of map data, which makes it possible to reduce power consumption.

In the present embodiment, it is possible for the convolution operation section to sequentially perform a convolution operation in bit data units from a piece of most significant bit data to a piece of least significant bit data on the basis of the plurality of pieces of coefficient data included in the piece of weighting coefficient data, which makes it possible to reduce power consumption.

In the present embodiment, the piece of processing target data includes a plurality of pieces of data each including a plurality of pieces of bit data, and the plurality of pieces of word data includes a piece of second word data including two or more pieces of most significant bit data provided side by side, the two or more pieces of most significant bit data being in two or more pieces of data among the plurality of pieces of data, which makes it possible to reduce power consumption.

### Modification Example 1

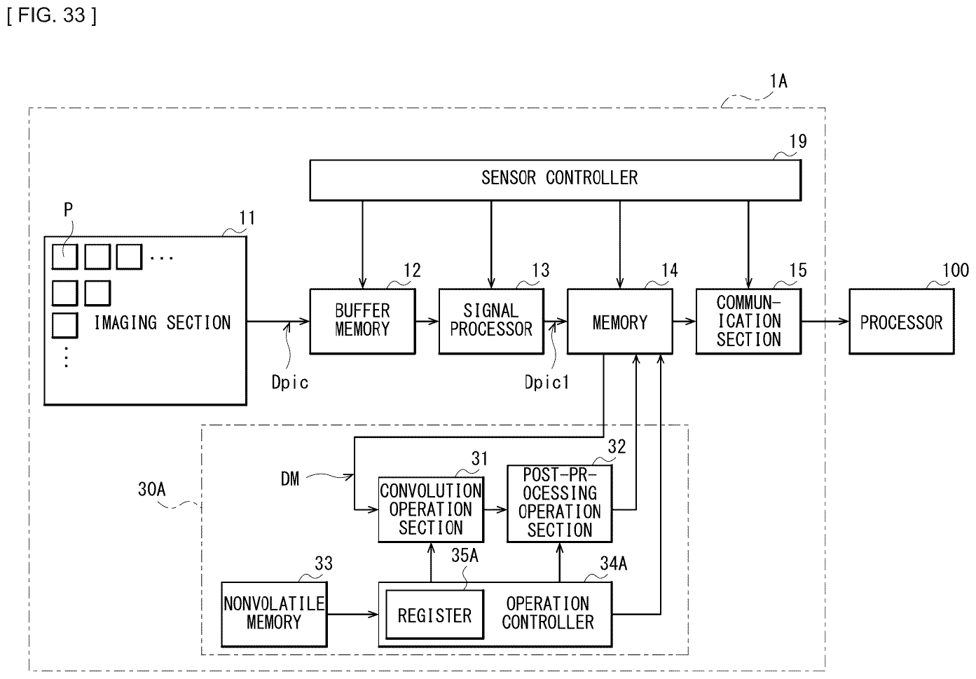

In the embodiment described above, both the piece of data DM and the piece of weighting coefficient data DW are stored in the memory 14, but this is not limitative. Instead of this, for example, as with an imaging device 1A illustrated in FIG. 33, the piece of weighting coefficient data DW may be stored in a register. The imaging device 1 includes a recognition processor 30A. The recognition processor 30A includes an operation controller 34A. The operation controller 34A includes a register 35A. The register 35A is configured to store the piece of weighting coefficient data DW. The operation controller 34A stores, in the register 35A, the piece of weighting coefficient data DW included in the model parameter supplied from the nonvolatile memory 33. Thereafter, the operation controller 34A supplies the piece of weighting coefficient data DW to the convolution operation section 31. Here, the memory 14 and the register 35A correspond to specific examples of a “storage section” in an embodiment of the present disclosure.

### Modification Example 2

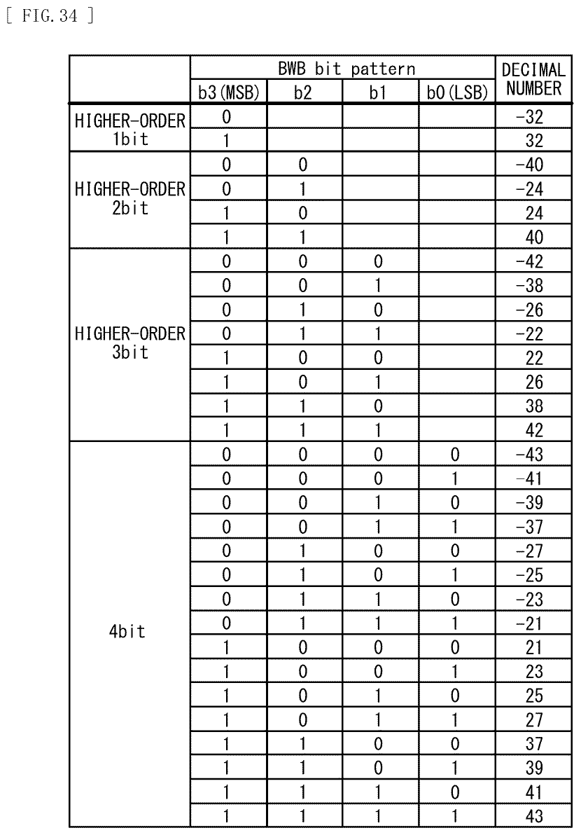

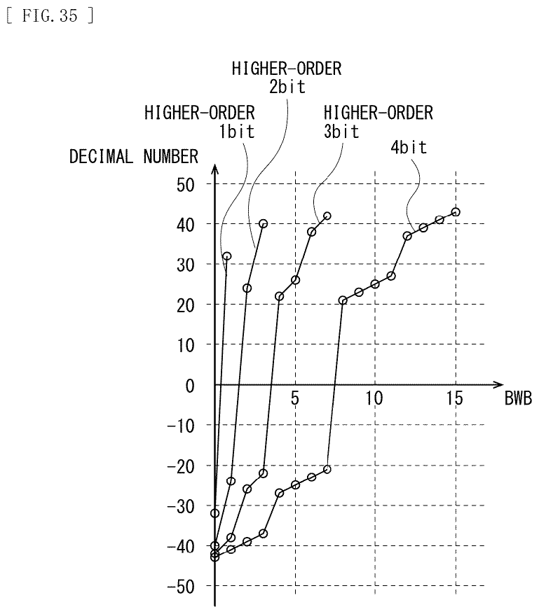

In the embodiment described above, as illustrated in FIGS. 17 and 18, in the piece of data in the bit-wise binary format, the decimal number changes linearly with change in the piece of data (in binary number), but this is not limitative. Instead of this, for example, as illustrated in FIGS. 34 and 35, the decimal number may not change linearly with change in the piece of data (in binary number). In this example, in a case where a piece of data is converted into a decimal number, for example, the value “1” in the bit b3 is converted into “+32” (=2\hat{ }5), and the value “0” in the bit b3 is converted into “−32” (=−2\hat{ }5). The value “1” in the bit b2 is converted into “+8” (=2\hat{ }3), and the value “0” in the bit b2 is converted into “−8” (=−2\hat{ }3). The value “1” in the bit b1 is converted into “+2” (=2\hat{ }1), and the value “0” in the bit b1 is converted into “−2” (=−2\hat{ }1). The value “1” in the bit b0 is converted into “+1” (=2\hat{ }0). The value “0” in the bit b1 is converted into “−1” (=−2\hat{ }0).

For example, the value “0000” corresponds to “−43” (=−32−8−2−1). For example, the value “0111” corresponds to “−21” (=−32+8+2+1). The value “1000” corresponds to “21” (=+32−8−2−1). The value “1111” corresponds to “43” (=+32+8+2+1).

It is possible to use only higher-order 1 bit (the bit b3) among such pieces of data of 4 bits. For example, the value “0” in the piece of data of the higher-order 1 bit corresponds to “−32” and the value “1” in the piece of data of the higher-order 1 bit corresponds to “32”.

In addition, for example, it is possible to use, for example, only higher-order 2 bits (the bits b3 and b2) among the pieces of data of 4 bits. For example, the value “00” in the pieces of data of higher-order 2 bits corresponds to “−40” (=−32−8). The value “01” in the pieces of data of higher-order 2 bits corresponds to “−24” (=−32+8). The value “10” in the pieces of data of higher-order 2bits corresponds to “24” (=+32−8). The value “11” in the pieces of data of higher-order 2 bits corresponds to “40”(=+32+8).

In addition, for example, it is possible to use, for example, only higher-order 3 bits (the bits b3, b2, and b1) among such pieces of data of 4 bits. For example, the value “000” in the pieces of data in higher-order 3 bits corresponds to “−42” (=−32−8−2). The value “011” in the pieces of data in higher-order 3 bits corresponds to “−22” (=−32+8+2). The value “100” in the pieces of data in higher-order 3 bits corresponds to “32” (=+32−8−2). The value “111” in the pieces of data in higher-order 3 bits corresponds to “42” (=+32+8+2).

Thus, as illustrated in FIG. 35, the decimal number changes with change in the piece of data (binary number). It is to be noted that this is not limitative, and it is also possible to achieve, for example, characteristics such as a logarithmic function or an exponential function by changing the weight of each digit.

### Modification Example 3

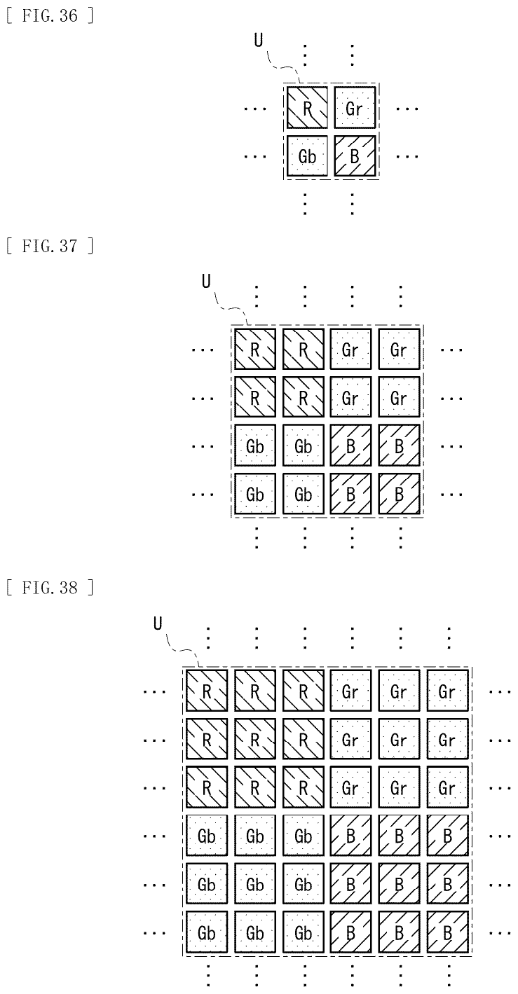

In the embodiment described above, as illustrated in FIG. 36, the plurality of light-receiving pixels P in the pixel array 21 is arranged in units U of four light-receiving pixels P including the light-receiving pixel provided with the red (R) color filter, the light-receiving pixels provided with the green (Gr and Gb) color filters, and the light-receiving pixel provided with the blue (B) color filter, but this it not limitative. The present modification example is described in detail below.

FIG. 37 illustrates a configuration example of the unit U according to the present modification example. In this pixel array 21, the plurality of light-receiving pixels P is arranged in units U of sixteen light-receiving pixels P. The sixteen light-receiving pixels P in the unit U are arranged in four rows and four columns. In this unit U, the light-receiving pixels P provided with the red (R) color filters are arranged in two rows and two columns at the upper left, the light-receiving pixels P provided with the green (Gr) color filters are arranged in two rows and two column at the upper right, the light-receiving pixels P provided with the green (Gb) color filters are arranged in two rows and two columns at the lower left, and the light-receiving pixels P provided with the blue (B) color filters are arranged in two rows and two columns at the lower right.

FIG. 38 illustrates a configuration example of the unit U according to the present modification example. In this pixel array 21, the plurality of light-receiving pixels P is arranged in units U of thirty six light-receiving pixels P. The thirty six light-receiving pixels in the unit U are arranged in six rows and six columns. In the unit U, the light-receiving pixels P provided with the red (R) color filters are arranged in three rows and three columns at the upper left, the light-receiving pixels P provided with the green (Gr) color filters are arranged in three rows and three column at the upper right, the light-receiving pixels P provided with the green (Gb) color filters are arranged in three rows and three columns at the lower left, and the light-receiving pixels P provided with the blue (B) color filters are arranged in three rows and three columns at the lower right.

FIG. 39 illustrates a configuration example of the unit U according to the present modification example. In this pixel array 21, the plurality of light-receiving pixels P is arranged in units U of four light-receiving pixels P. The four light-receiving pixels P in the unit U are arranged in two rows and two columns. In this unit U, the light-receiving pixel P provided with the red (R) color filter is provided at the upper left, the light-receiving pixel provided with a yellow (Y) color filter is provided at the upper right, the light-receiving pixel provided with a green (G) color filter is provided at the lower left, and the light-receiving pixel provided with the blue (B) color filter is provided at the lower right. The yellow (Y) color filter is what is called a complementary color filter.

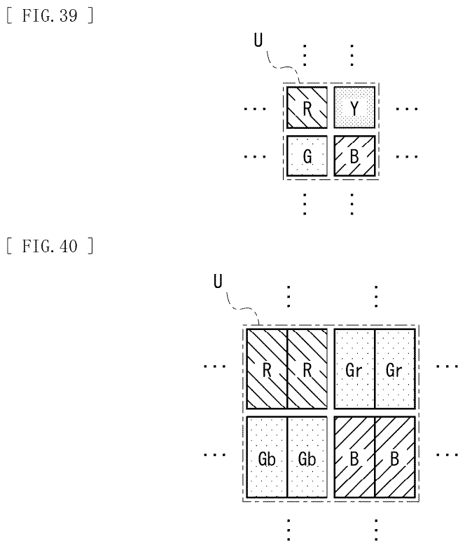

FIG. 40 illustrates a configuration example of the unit U according to the present modification example. In this pixel array 21, a pixel pair including two light-receiving pixels P provided with the red (R) color filters is provided at the upper left, a pixel pair including two light-receiving pixels P provided with the green (Gr) color filters is provided at the upper right, a pixel pair including two light-receiving pixels P provided with the green (Gb) color filters is provided at the lower left, and a pixel pair including two light-receiving pixels P provided with the blue (B) color filters is provided at the lower right. The two light-receiving pixels P included in the pixel pair are what is called phase-difference pixels. One on-chip lens is provided for these two light-receiving pixels P. Accordingly, in the two light-receiving pixels P, images are shifted from each other. Thus, in the imaging device 1, it is possible to generate the piece of image data Dpic, and also generate a piece of phase-difference data on the basis of what is called an image plane phase difference detected by a plurality of pixel pairs.

### Modification Example 4

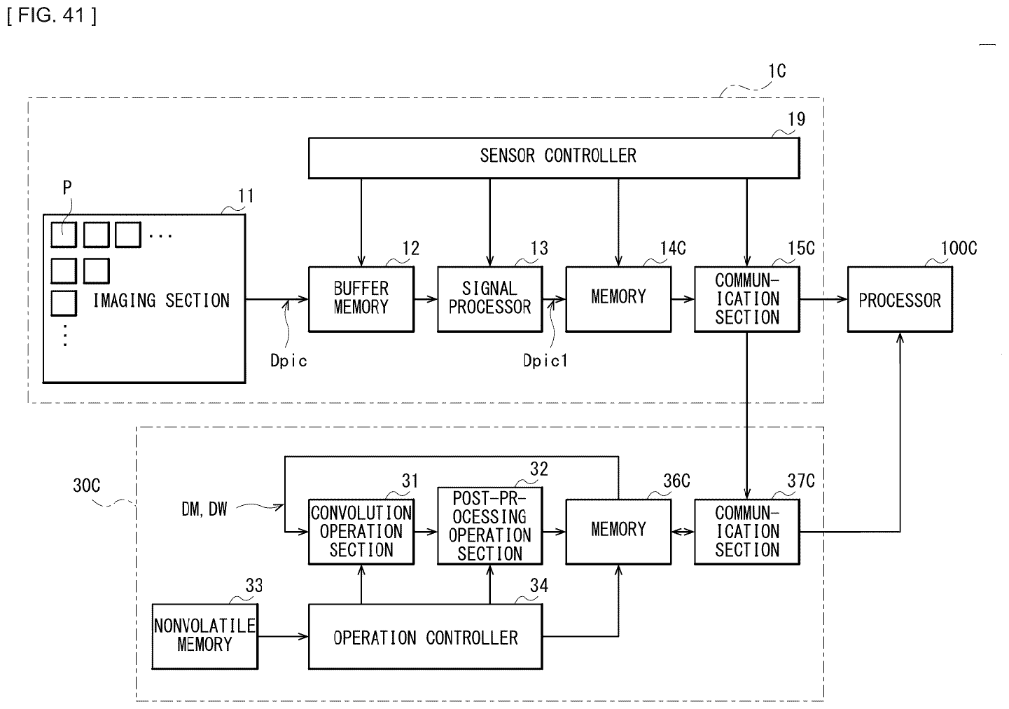

In the embodiment described above, the recognition processor 30 is provided in the imaging device 1, but this is not limitative. For example, as illustrated in FIG. 41, a recognition processor may be provided separately from the imaging device 1. This system includes an imaging device 1C, a recognition processing device 30C, and a processor 100C.

The imaging device 1C includes the imaging section 11, the buffer memory 12, the signal processor 13, a memory 14C, a communication section 15C, and the sensor controller 19. The memory 14C is configured to store, for example, the piece of image data Dpic1 supplied from the signal processor 13. The communication section 15C is configured to transmit the piece of image data Dpic1 supplied from the memory 14C to the processor 100C and the recognition processing device 30C.

The recognition processing device 30C includes the convolution operation section 31, the post-processing operation section 32, the nonvolatile memory 33, the operation controller 34, a memory 36C, and a communication section 37C. The memory 36C is configured to store the piece of image data Dpic1 supplied from the imaging device 1C, and the piece of data DM and the piece of weighting coefficient data DW that are to be used when the recognition processor 30 performs recognition processing. The communication section 37C is configured to receive the piece of image data Dpic1 transmitted from the imaging device 1C, and supply this piece of image data Dpic1 to the memory 36C and transmit, to the processor 100C, a piece of data representing a processing result of the recognition processing supplied from the memory 14C.

The processor 100C is configured to perform predetermined processing on the basis of the piece of image data supplied from the imaging device 1C and the processing result of the recognition processing supplied from the recognition processing device 30C.

### Modification Example 5

In the embodiment described above, the present technology is applied to the imaging device, but this is not limitative. The present technology may be applied to a distance measurement device using a ToF (Time of Flight) or may be applied to a dynamic vision sensor that detects an event in pixel units.

### Other Modification Examples

In addition, two or more of these modification examples may be combined.

Although the present technology has been described above with reference to some embodiments and some modification examples, the present technology is not limited to these embodiments and the like, and may be modified in a variety of ways.

For example, in each embodiment described above, the pieces of data of 8 bits are used, but this is not limitative. Pieces of data of 7 bits or less may be used, or pieces of data of 9 bits or more may be used.

It is to be noted that the effects described herein are merely illustrative and non-limiting, and may further include other effects.

It is to be noted that the present technology may have the following configurations. According to the present technology having the following configurations, it is possible to reduce power consumption.

(1)

An information processing device including:
a storage section that is configured to store a plurality of pieces of word data each including at least one of a piece of processing target data or a piece of weighting coefficient data, and is configured to be accessed in word data units;
a convolution operation section that is configured to perform a convolution operation on the basis of the piece of processing target data and the piece of weighting coefficient data; and
a post-processing operation section that is configured to perform a predetermined operation on the basis of an operation result of the convolution operation and store the operation result as the piece of processing target data in the storage section, in which
the piece of weighting coefficient data includes a plurality of pieces of coefficient data each including a plurality of pieces of bit data, and
the plurality of pieces of word data includes a piece of first word data including two or more pieces of most significant bit data provided side by side, the two or more pieces of most significant bit data being in two or more pieces of coefficient data among the plurality of pieces of coefficient data.
   (2)

The information processing device according to (1), in which
the piece of processing target data includes a plurality of pieces of map data,
the plurality of pieces of coefficient data in the piece of weighting coefficient data corresponds to the plurality of respective pieces of map data, and
the piece of first word data includes the two or more pieces of most significant bit data provided side by side, the two or more pieces of most significant bit data being in the two or more pieces of coefficient data among the plurality of pieces of coefficient data corresponding to the plurality of respective pieces of map data.
   (3)

The information processing device according to (1), in which
the piece of processing target data includes a single piece of map data,
the plurality of pieces of coefficient data in the piece of weighting coefficient data corresponds to the single piece of map data, and
the piece of first word data includes the two or more most significant bit data provided side by side, the two or more most significant bit data being in the two or more pieces of coefficient data among the plurality of pieces of coefficient data corresponding to the single piece of map data.
   (4)

The information processing device according to any one of (1) to (3), in which the convolution operation section is configured to sequentially perform the convolution operation in bit data units from the piece of most significant bit data to a piece of least significant bit data on the basis of the plurality of pieces of coefficient data included in the piece of weighting coefficient data.

(5)

The information processing device according to (4), in which the convolution operation section is configured to perform the convolution operation using a value having a positive or negative sign corresponding to the piece of most significant bit data upon performing the convolution operation using the piece of most significant bit data.

(6)

The information processing device according to any one of (1) to (5), in which the piece of weighting coefficient data include a piece of data in a bit-wise binary format.

(7)

The information processing device according to any one of (1) to (6), in which the information processing device is configured to perform operation processing of a neural network.

(8)

The information processing device according to any one of (1) to (7), in which
the piece of processing target data includes a plurality of pieces of data each including a plurality of pieces of bit data, and
the plurality of pieces of word data includes a piece of second word data including two or more pieces of most significant bit data provided side by side, the two or more pieces of most significant bit data being in two or more pieces of data among the plurality of pieces of data.
   (9)

The information processing device according to (8), in which the post-processing operation section is configured to change an arrangement of pieces of data to be stored in the storage section upon storing the operation result as the piece of processing target data in the storage section.

(10)

The information processing device according to (9), in which the post-processing operation section is configured to change the arrangement of the pieces of data in the storage section to a first arrangement or a second arrangement by performing transposition processing.

(11)

The information processing device according to (10), in which
the piece of processing target data includes a piece of data in a first data format in which the pieces of data are arranged in the first arrangement, or a piece of data in a second data format in which the pieces of data are arranged in the second arrangement,
the convolution operation section is configured to perform the convolution operation on the basis of the piece of processing target data in the first data format, and is configured to perform the convolution operation on the basis of the piece of processing target data in the second data format,
the post-processing operation section is configured to change the arrangement of the pieces of data to be stored in the storage section to the second arrangement in a case where the convolution operation section performs the convolution operation on the basis of the piece of processing target data in the second data format after performing the convolution operation on the basis of the piece of processing target data in the first data format, and
the post-processing operation section is configured to change the arrangement of the pieces of data to be stored in the storage section to the first arrangement in a case where the convolution operation section performs the convolution operation on the basis of the piece of processing target data in the first data format after performing the convolution operation on the basis of the piece of processing target data in the second data format.
   (12)

The information processing device according to (10) or (11), in which the post-processing operation section includes a plurality of buffer memories provided side by side in a first direction and a second direction, and is configured to perform the transposition processing by changing a direction in which pieces of data are outputted from the plurality of buffer memories to the first direction or the second direction.

(13)

The information processing device according to any one of (1) to (12), further including a photodetecting section, in which
the piece of processing target data includes a piece of data representing a result of detection by the photodetecting section.
   (14)

An information processing device including:
a storage section that is configured to store a plurality of pieces of word data each including at least one of a piece of processing target data or a piece of weighting coefficient data, and is configured to be accessed in word data units;
a convolution operation section that is configured to perform a convolution operation on the basis of the piece of processing target data and the piece of weighting coefficient data; and
a post-processing operation section that is configured to perform a predetermined operation on the basis of an operation result of the convolution operation and store the operation result as the piece of processing target data in the storage section, in which
the piece of processing target data includes a plurality of pieces of data each including a plurality of pieces of bit data, and
the plurality of pieces of word data includes a piece of second word data including two or more pieces of most significant bit data provided side by side, the two or more pieces of most significant bit data being in two or more pieces of data among the plurality of pieces of data.

The present application claims the benefit of Japanese Priority Patent Application JP2022-132955 filed with the Japan Patent Office on Aug. 24, 2022, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An information processing device comprising:
a storage section that is configured to store a plurality of pieces of word data each including at least one of a piece of processing target data or a piece of weighting coefficient data, and is configured to be accessed in word data units;
a convolution operation section that is configured to perform a convolution operation on a basis of the piece of processing target data and the piece of weighting coefficient data; and
a post-processing operation section that is configured to perform a predetermined operation on a basis of an operation result of the convolution operation and store the operation result as the piece of processing target data in the storage section, wherein
the piece of weighting coefficient data includes a plurality of pieces of coefficient data each including a plurality of pieces of bit data, and
the plurality of pieces of word data includes a piece of first word data including two or more pieces of most significant bit data provided side by side, the two or more pieces of most significant bit data being in two or more pieces of coefficient data among the plurality of pieces of coefficient data.

2. The information processing device according to claim 1, wherein
the piece of processing target data includes a plurality of pieces of map data,
the plurality of pieces of coefficient data in the piece of weighting coefficient data corresponds to the plurality of respective pieces of map data, and
the piece of first word data includes the two or more pieces of most significant bit data provided side by side, the two or more pieces of most significant bit data being in the two or more pieces of coefficient data among the plurality of pieces of coefficient data corresponding to the plurality of respective pieces of map data.

3. The information processing device according to claim 1, wherein
the piece of processing target data includes a single piece of map data,
the plurality of pieces of coefficient data in the piece of weighting coefficient data corresponds to the single piece of map data, and
the piece of first word data includes the two or more most significant bit data provided side by side, the two or more most significant bit data being in the two or more pieces of coefficient data among the plurality of pieces of coefficient data corresponding to the single piece of map data.

4. The information processing device according to claim 1, wherein the convolution operation section is configured to sequentially perform the convolution operation in bit data units from the piece of most significant bit data to a piece of least significant bit data on a basis of the plurality of pieces of coefficient data included in the piece of weighting coefficient data.

5. The information processing device according to claim 4, wherein the convolution operation section is configured to perform the convolution operation using a value having a positive or negative sign corresponding to the piece of most significant bit data upon performing the convolution operation using the piece of most significant bit data.

6. The information processing device according to claim 1, wherein the piece of weighting coefficient data comprises a piece of data in a bit-wise binary format.

7. The information processing device according to claim 1, wherein the information processing device is configured to perform operation processing of a neural network.

8. The information processing device according to claim 1, wherein
the piece of processing target data includes a plurality of pieces of data each including a plurality of pieces of bit data, and
the plurality of pieces of word data includes a piece of second word data including two or more pieces of most significant bit data provided side by side, the two or more pieces of most significant bit data being in two or more pieces of data among the plurality of pieces of data.

9. The information processing device according to claim 8, wherein the post-processing operation section is configured to change an arrangement of pieces of data to be stored in the storage section upon storing the operation result as the piece of processing target data in the storage section.

10. The information processing device according to claim 9, wherein the post-processing operation section is configured to change the arrangement of the pieces of data in the storage section to a first arrangement or a second arrangement by performing transposition processing.

11. The information processing device according to claim 10, wherein
the piece of processing target data comprises a piece of data in a first data format in which the pieces of data are arranged in the first arrangement, or a piece of data in a second data format in which the pieces of data are arranged in the second arrangement,
the convolution operation section is configured to perform the convolution operation on a basis of the piece of processing target data in the first data format, and is configured to perform the convolution operation on a basis of the piece of processing target data in the second data format,
the post-processing operation section is configured to change the arrangement of the pieces of data to be stored in the storage section to the second arrangement in a case where the convolution operation section performs the convolution operation on a basis of the piece of processing target data in the second data format after performing the convolution operation on a basis of the piece of processing target data in the first data format, and
the post-processing operation section is configured to change the arrangement of the pieces of data to be stored in the storage section to the first arrangement in a case where the convolution operation section performs the convolution operation on a basis of the piece of processing target data in the first data format after performing the convolution operation on a basis of the piece of processing target data in the second data format.

12. The information processing device according to claim 10, wherein the post-processing operation section includes a plurality of buffer memories provided side by side in a first direction and a second direction, and is configured to perform the transposition processing by changing a direction in which pieces of data are outputted from the plurality of buffer memories to the first direction or the second direction.

13. The information processing device according to claim 1, further comprising a photodetecting section, wherein the piece of processing target data comprises a piece of data representing a result of detection by the photodetecting section.

14. An information processing device comprising:
a storage section that is configured to store a plurality of pieces of word data each including at least one of a piece of processing target data or a piece of weighting coefficient data, and is configured to be accessed in word data units;
a convolution operation section that is configured to perform a convolution operation on a basis of the piece of processing target data and the piece of weighting coefficient data; and
a post-processing operation section that is configured to perform a predetermined operation on a basis of an operation result of the convolution operation and store the operation result as the piece of processing target data in the storage section, wherein
the piece of processing target data includes a plurality of pieces of data each including a plurality of pieces of bit data, and
the plurality of pieces of word data includes a piece of second word data including two or more pieces of most significant bit data provided side by side, the two or more pieces of most significant bit data being in two or more pieces of data among the plurality of pieces of data.
